(19) United States
(12) Patent Application Publication
(10) Pub. No.: US 2021/0238105 A1
(43) Pub. Date: Aug. 5, 2021

(54) MACHINE FOR MANUFACTURING COMPOSITE MATERIALS

(71) Applicant: Cortex Composites, Inc., Pacific Palisades, CA (US)

(72) Inventors: Curren Krasnoff, Pacific Palisades, CA (US); David Armstrong, Carlsbad, CA (US)

(73) Assignee: Cortex Composites, Inc., Pacific Palisades, CA (US)

(21) Appl. No.: 17/270,238

(22) PCT Filed: Aug. 21, 2019
(86) PCT No.: PCT/US2019/047541

§ 371 Date: Feb. 22, 2021

Related U.S. Application Data
(60) Provisional application No. 62/722,035, filed on Aug. 23, 2018.

(51) Int. Cl. C04B 40/00; B32B 13/04; B32B 7/12; B28B 19/00

(52) U.S. Cl. CPC C04B 40/0042; C04B 40/0071; C04B 2111/60; B32B 7/12; B28B 19/0092; B32B 13/04

(57) ABSTRACT

A system for making a cementitious composite includes a cementitious material supply system for dispensing a powdered cementitious material or a semi-powdered cementitious material into a receiving material. The receiving material includes a structural layer and a sealing layer. The structural layer includes an open continuous volume extending from a first side to a second side opposite the first side. The sealing layer is coupled to the first side. The cementitious material supply system is configured to dispense the powdered cementitious material or the semi-powdered cementitious material into the open continuous volume to fill the open continuous volume.

### CROSS-REFERENCE TO RELATED PATENT APPLICATIONS

This application claims the benefit of and priority to U.S. Provisional Patent Application No. 62/722,035, filed Aug. 23, 2018, the entire disclosure of which is hereby incorporated by reference herein.

### BACKGROUND

The present disclosure relates to apparatuses and methods for the production of cementitious composites. A cementitious composite includes layers of planar materials that are bonded to one another in a particular arrangement. The composite also includes a volume of cementitious material encased between two or more layers. There is a need for techniques and systems that facilitate the production of these cementitious composites.

### SUMMARY

One exemplary embodiment relates to a system for making a cementitious composite. The system includes a cementitious material supply system for dispensing a powdered cementitious material or a semi-powdered cementitious material into a receiving material. The receiving material includes a structural layer and a sealing layer. The structural layer includes an open continuous volume extending from a first side to a second side opposite the first side. The sealing layer is coupled to the first side. The cementitious material supply system is configured to dispense the powdered cementitious material or the semi-powdered cementitious material into the open continuous volume to fill the open continuous volume.

In some embodiments, the cementitious material supply system dispenses the powdered cementitious material or the semi-powdered cementitious material from the second side of the structural layer such that the structural layer is filled from the first side to the second side.

Another exemplary embodiment relates to a method of making a cementitious composite. The method includes providing a receiving material including a structural layer and a sealing layer. The structural layer includes an open continuous volume extending from a first side to a second side opposite the first side. The sealing layer is coupled to the first side. The method additionally includes dispensing a powdered cementitious material or a semi-powdered cementitious material into the open continuous volume to fill the open continuous volume.

In some embodiments, dispensing the powdered cementitious material or the semi-powdered cementitious material includes filling the structural layer from the first side to the second side.

The invention is capable of other embodiments and of being carried out in various ways. Alternative exemplary embodiments relate to other features and combinations of features as may be recited herein.

### BRIEF DESCRIPTION OF THE DRAWINGS

The disclosure will become more fully understood from the following detailed description taken in conjunction with the accompanying drawings wherein like reference numerals refer to like elements, in which:

FIG. 1 is a schematic representation of a manufacturing method for a cementitious composite, according to an exemplary embodiment;

FIG. 2 is a front perspective view of a manufacturing system for a cementitious composite, according to an exemplary embodiment;

FIG. 3 is a rear perspective view of the manufacturing system of FIG. 2;

FIG. 4 is a perspective view of an impermeable layer unwinding system and adhesive application system, according to an exemplary embodiment;

FIG. 5 is a front perspective view of a fume hood for an adhesive application system, according to an exemplary embodiment;

FIG. 6 is a schematic illustration of an aerosolized adhesive application system, according to an exemplary embodiment;

FIG. 7 is a perspective view of an impermeable layer cutting system, according to an exemplary embodiment;

FIG. 8 is a perspective view of a structure layer unwinding system, according to an exemplary embodiment;

FIG. 9 is a tensioning system for an impermeable layer unwinding system, according to an exemplary embodiment;

FIG. 10 is a schematic representation of a method of depositing cement onto a structure layer, according to an illustrative embodiment;

FIG. 11 is a supply and dispensing system for a cementitious material, according to an exemplary embodiment;

FIG. 12 is a perspective view of an unbagging system, according to an exemplary embodiment;

FIG. 13 is a side sectional view of a bucket elevator, according to an exemplary embodiment;

FIG. 14 is a housing and conveyer for the supply and dispensing system of FIG. 11, according to an exemplary embodiment;

FIG. 15 is a side view of a dust extraction system, according to an exemplary embodiment;

FIG. 16 is a compression and cementitious material distribution system, according to an exemplary embodiment;

FIG. 17 is a side sectional view of a partially manufactured cementitious composite passing through a trailing edge swiping system, according to an exemplary embodiment;

FIG. 18 is a trailing edge swiping system used as part of a compression and cementitious material distribution system, according to an exemplary embodiment;

FIG. 19 is a perspective view of a heating system used to heat a mesh layer of a cementitious composite, according to an exemplary embodiment;

FIG. 20 is a perspective sectional view of the heating system of FIG. 19, according to an exemplary embodiment;

FIG. 21 is a perspective view of a permeable layer unwinding, adhesive application, bonding, and cutting system, according to an exemplary embodiment;

FIG. 22 is a back side perspective view of the bonding and cutting system of FIG. 21, according to an exemplary embodiment;

FIG. 23 is a front side perspective view of the bonding and cutting system of FIG. 21, according to an exemplary embodiment;

FIG. 24 is a top perspective view of a motor and linear actuator for the bonding and cutting system of FIG. 21, according to an exemplary embodiment;

FIG. 25 is a reproduction of FIG. 23 that shows a cementitious composite as a leading edge of the composite passes through the bonding and cutting system of FIG. 21, according to an exemplary embodiment;

FIG. 26 is a reproduction of FIG. 23 that shows a cementitious composite as a trailing edge of the composite passes through the bonding and cutting system of FIG. 21, according to an exemplary embodiment;

FIG. 27 is a top view of an edge rolling system for a manufacturing system for a cementitious composite, according to an exemplary embodiment;

FIG. 28 is a rear sectional view of a cementitious composite after passing through the edge rolling system of FIG. 27, according to an exemplary embodiment;

FIG. 29 is a perspective view of the edge rolling system of FIG. 27, according to an exemplary embodiment;

FIG. 30 is a schematic representation of a method of initially feeding and winding a cementitious material, according to an exemplary embodiment;

FIG. 31 is a perspective view of a winding system for a cementitious composite, according to an exemplary embodiment;

FIG. 32 is a side view of the winding system of FIG. 31, according to an exemplary embodiment;

FIG. 33 is a side view of the winding system of FIG. 31 that shows part of a winding operation, according to an exemplary embodiment;

FIG. 34 is a side view of the winding system of FIG. 31 that shows part of a winding operation, according to an exemplary embodiment;

FIG. 35 is a perspective view of a tracked manufacturing system for a cementitious composite, according to an exemplary embodiment;

FIG. 36 is a perspective view of a distribution hopper, according to an exemplary embodiment;

FIG. 37 is a partial perspective view of a screed for a distribution hopper, according to an exemplary embodiment;

FIG. 38 is a perspective view of a manufacturing system for a cementitious composite including a secondary track for an unbagging system, according to an exemplary embodiment;

FIG. 39 is a top view of the manufacturing system for a cementitious composite of FIG. 38, according to an exemplary embodiment;

FIG. 40 is a side view of the manufacturing system for a cementitious composite of FIG. 38, according to an exemplary embodiment;

FIG. 41 is a side view of a manufacturing system for a cementitious composite without an adhesive application system or a heating system, according to an exemplary embodiment;

FIG. 42 is a perspective view of a manufacturing system for a cementitious composite on a repositionable track bed, according to an exemplary embodiment;

FIG. 43 is a perspective view of a tracked manufacturing system for a cementitious composite and a single cement distribution hopper, according to an exemplary embodiment;

FIG. 44 is a perspective view of a tracked manufacturing system for a cementitious composite including a floor unloading system, according to an exemplary embodiment;

FIG. 45 is a perspective view of a tracked manufacturing system for a cementitious composite including a floor unloading system with winches, according to an exemplary embodiment;

FIG. 46 is a perspective view of a winding system for a cementitious composite, according to an exemplary embodiment;

FIG. 47 is a perspective view of the winding system of FIG. 46 that shows a first winding operation, according to an exemplary embodiment;

FIG. 48 is a perspective view of the winding system of FIG. 46 that shows a second winding operation, according to an exemplary embodiment; and

FIG. 49 is a perspective view of the winding system of FIG. 46 that shows a third winding operation, according to an exemplary embodiment.

### DETAILED DESCRIPTION

Before turning to the figures, which illustrate the exemplary embodiments in detail, it should be understood that the application may be not limited to the details or methodology set forth in the description or illustrated in the figures. It should also be understood that the terminology may be for the purpose of description only, and should not be regarded as limiting.

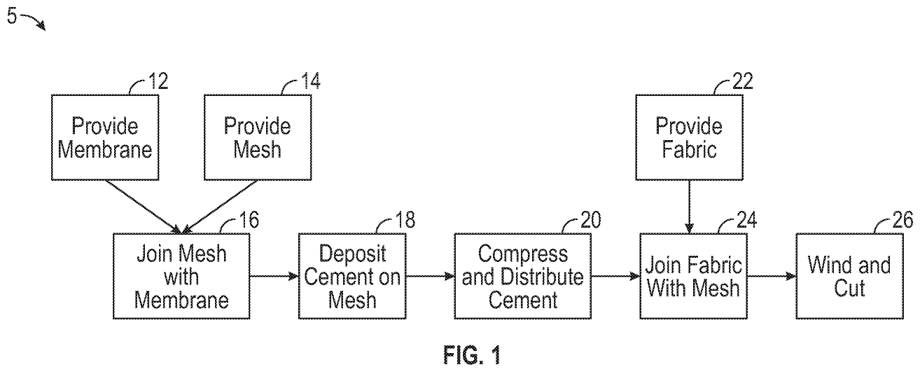

Referring generally to the figures, and particularly FIGS. 1-3, the various exemplary embodiments disclosed herein relate to systems and methods for manufacturing a cementitious composite, which may be used as a replacement for traditional concrete reinforcement materials such as fibers, rebar, etc. As compared with traditional concrete reinforcement materials, cementitious composites may provide enhanced structural performance. Cementitious composites may include a dry cementitious mixture embedded in, and/or contained by, a structural layer (e.g., a porous planar sheet or mat, a mesh, etc.). The structural layer defines a continuous open volume that extends a full height of the structural layer, from a first side (e.g., upper surface) of the structural layer to a second side (e.g., a lower surface) of the structural layer. The cement fills the continuous volume of the structural layer. The structural later may be positioned between a sealing layer (e.g., an impermeable layer, a membrane, etc.) and a containment layer (e.g., a permeable layer, a fabric, etc.), which encase the cementitious mixture within the composite. Additional information regarding cementitious composites may be found in U.S. Pat. No. 9,187,902, filed Feb. 20, 2014, U.S. patent application Ser. No. 15/767,191, filed Nov. 4, 2016, and International Application No. PCT/US2018/027984, filed Apr. 17, 2018, all of which are incorporated by reference herein in their entireties.

At least one exemplary embodiment relates to a method for manufacturing a cementitious composite. The method includes providing an impermeable layer and a structural layer, bonding the impermeable layer to the structural layer, depositing a cementitious material onto the structural layer, and compressing and distributing the cementitious material. The method further includes providing a permeable layer and bonding the permeable layer to the impermeable layer. The method further includes winding and cutting the cementitious composite.

At least one exemplary embodiment relates to a system for manufacturing a cementitious composite. The system includes an unwinding system for each of an impermeable, a structural, and a permeable layer. The system also includes adhesive application systems and compression systems to facilitate bonding of the different layers. The system includes a cement supply and dispensing system that is configured to deposit a cementitious material onto the structural layer. The cement supply and dispensing system includes an unbagging system (e.g., in an embodiment where the cement is provided in pre-mixed/pre-filled bags), a bag-to-hopper transfer system, a hopper-to-dispenser transfer system, and a distribution system. In other embodiments, the cement is transferred directly from silos or from a mixer for the cementitious material. In yet other embodiments, the cement may come from a hopper or any other form of cement delivery device.

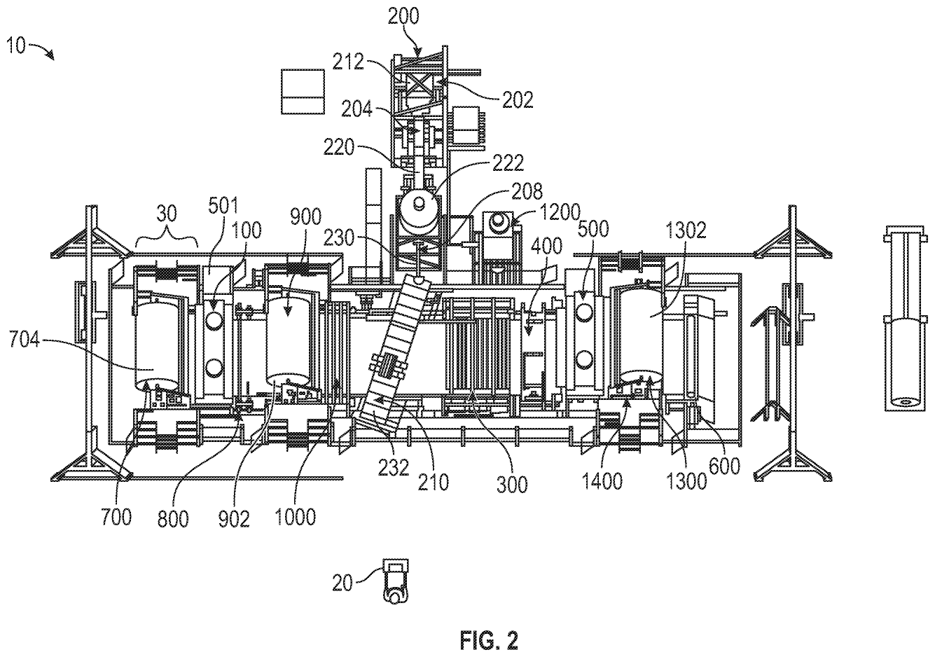

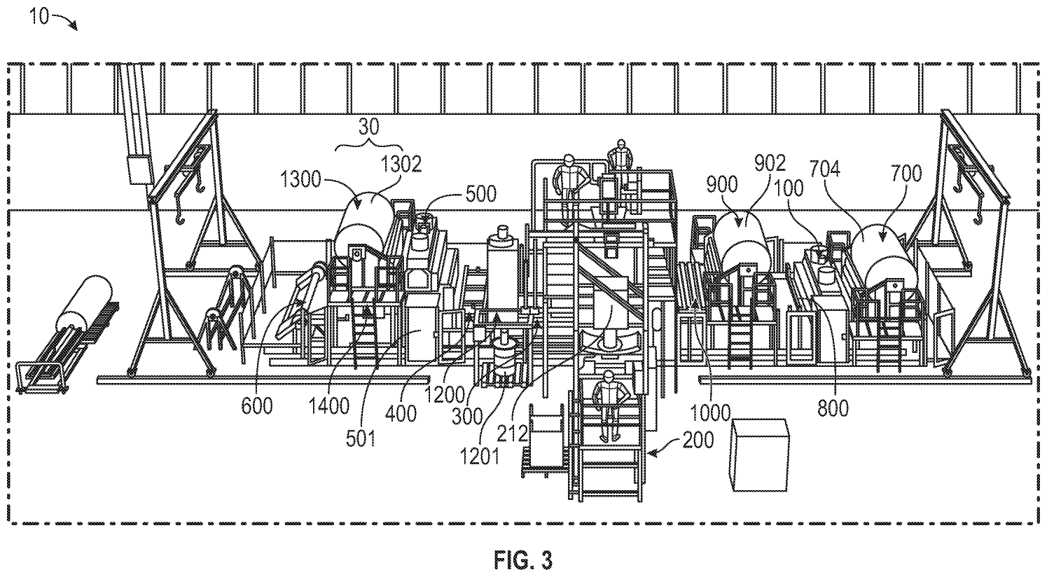

A schematic representation of a method 5 of making a cementitious composite is shown in FIG. 1. An exemplary embodiment of a manufacturing system 10 for making the cementitious composite is shown in FIGS. 2-3. The method 5 includes providing an impermeable layer or membrane 704, at 12, and a structural layer or mesh 902, at 14. Each of the membrane 704 and the mesh 902 may be provided in a form of a bulk roll of material as shown in FIGS. 2-3, where each of the rolls are configured to supply the required amounts of material at the required rate to other parts of the manufacturing system 10. The machine rates (e.g., material feed rates, etc.) can be modified for various production lengths and input material geometries. In some embodiments, any of the membrane 704, mesh 902, or fabric 1302 may be fed into the manufacturing system 10 as a flat sheet instead of a bulk roll. The manufacturing system 10 may be configured to clamp onto the flat sheet and draw the flat sheet along the production line. By way of example, the mesh 902 and/or membrane 704 may be at least partially suspended above the manufacturing system 10 or toward a rear (e.g., back) of the manufacturing system 10 and drawn into the manufacturing system 10 from the rear. In other embodiments, the mesh 902 and/or membrane 704 may be fed horizontally through an opening on the rear of the manufacturing system 10. Similarly, the fabric 1302 may be laid out in front of the manufacturing system, opposite the rear, and may be fed horizontally into the manufacturing system 10. In other embodiments, one, or a combination of the mesh 902, the membrane 704, and the fabric 1302 may be laid out to a side of the manufacturing system 10 and drawn into the manufacturing system 10 through a device that changes the angle and/or position of the material before the material is fed into the manufacturing system 10.

Control of the unwinding operation for each roll may be performed automatically or through a human-machine interface 40, which may also be used to control various other input metering and system control operations as will be further described. The method 5 of FIG. 1 further includes joining the mesh 902 with the membrane 704, at 16. Block 16 may include providing a layer of adhesive to the membrane 704. In the exemplary embodiment shown in FIGS. 2-3, the manufacturing system 10 includes a first adhesive application system 100 configured to apply a layer of adhesive to the membrane 704 prior to joining the membrane 704 to the mesh 902. Block 16 may additionally include aligning the membrane 704 with the mesh 902 and pressing the membrane 704 and the mesh 902 together. As shown in FIGS. 2-3, the manufacturing system 10 further includes a first compression system (not shown) including a set of rollers configured to apply a predetermined load to push the membrane 704 and mesh 902 layers together.

The method 12 of FIG. 1 further includes depositing a cementitious material or cement onto a mesh side of the bonded layers (e.g., onto the mesh 902), at 18. The cement may be a powdered cementitious material (e.g., having approximately uniform cementitious material particle size) or a semi-powdered cementitious material (e.g., having a non-uniform cementitious material particle size). Block 18 may include mixing the cement. The cement may be mixed from bulk silos that include different constituents (e.g., ingredients) for the cement. The constituents of the cement may be metered into an industrial mixer from the silos. The metering may be performed by opening each silo over a predefined time period, or by weighing each constituent. In other embodiments, the constituents may be hand proportioned into the mixer. Block 18 may include providing the cement to the manufacturing system 10. For example, cement may be provided in the form of prepacked bags or from bulk silos. In other embodiments, the cement may be provided from a silo or stationary truck. Block 18 may additionally include dispensing (e.g., unloading, depositing, dumping, etc.) the cement. As shown in FIGS. 2-3, the manufacturing system 10 includes a cement supply and dispensing system 200 (e.g., a cementitious material supply system) that is configured to dispense the cement evenly across a top surface of the mesh 902, from an area above the mesh 902, which fills the continuous volume defined by the mesh 902 from the membrane facing side of the mesh 902 (e.g., bottom side, opposite the supply equipment) to an upper side of the mesh 902 opposite the membrane facing side. The supply and dispensing system 200 includes an unbagging system 202, a bag-to-hopper transfer system 204, a hopper-to-dispenser transfer system 208, and a distribution system 210. The unbagging system 202, the bag-to-hopper transfer system 204, and the hopper-to-dispenser transfer system 208 are configured to work in concert to transfer cement 212 from pre-mixed/pre-filled sacks into the distribution system 210. The distribution system 210 is configured to receive a metered supply of cement 212 and dispense the cement 212 onto the top surface of the mesh 902.

Block 18 may further include moving the mesh 902 relative to the distribution system 210 and releasing the cement 212 from the distribution system 210 in an area above the mesh 902, along a width of the mesh 902, at a predefined flow rate, such that the cement 212 falls onto the mesh 902 as it moves past the distribution system 210. In some embodiments, the mesh 902 (see FIGS. 2-3), the mesh 902 is moved while the distribution system 210 remains stationary. In other embodiments, the distribution system 210 is moved (e.g., via a cart, etc.) while the mesh 902 remains stationary. In other embodiments, the distribution system 210 is connected to bulk silos instead of an unbagging system 202 and configured to receive cement 212 directly from the silos. In yet other embodiments, the distribution system 210 is configured to receive cement 212 from a hopper that is configured to receive cement 212 from the silos. The cement 212 may be applied continuously to the mesh 902 (across the width of the mesh 902), with an over mesh 902 spreader (e.g., a hopper, screw feeder, silo, or truck silo that dispenses cement 212 continuously throughout a production run for a single mat of cementitious composite). Alternatively, or in combination, the cement 212 may be applied to the mesh as discrete, non-continuous batches (e.g., discrete piles on the mesh 902). In these instances a separate spreading operation may be used to ensure the cement 212 is approximately uniformly distributed along the length (and/or width) of the cementitious composite.

In various exemplary embodiments, the manufacturing system 10 may include a cement spreading system configured to distribute the cement from piles on top of the mesh 902 along the length and or width of the mesh 902 (e.g., across an upper surface of the mesh 902). The spreading system may include at least one paddle to spread out the cement evenly into the mesh 902 to fill the mesh 902 fully before any compression of the mesh 902 is performed. Alternatively, or in combination, a plurality of paddles may be positioned before and/or after other subsystems (e.g., before and after a first compression stage, before or after a second compression stage, after each hopper or other feed device used to dispense cement over the mesh 902, etc.). The spreading may be performed diagonally across the mesh 902, or with a spreader oriented substantially perpendicular and/or parallel to the feed direction that drags across an upper surface of the mesh 902. In other embodiments, the spreading may be performed by rotation of a spreading device across the upper surface (e.g., with multiple paddles that cover discrete portions across a width of the cementitious composite, etc.).

As shown in FIG. 1, the method 5 includes compressing and distributing the cement 212 onto the mesh 902, at 20. Block 20 may include moving the mesh 902 relative to the distribution system 210, spreading the cement 212, and/or compressing the cement 212 into the mesh 902. In the exemplary embodiment of FIGS. 2-3, the cement covered mesh 902 is transferred from beneath the distribution system 210 to a compression and cement distribution system 300, which impregnates and/or fills the cement 212 into the fibers of the mesh 902 and prepares the mesh 902 for another joining operation. The operation 20 of compressing and distributing the cement 212 may include passing the mesh 902 through a series of compression stages, each stage configured to independently apply a predetermined force to push the layers together and/or coax the cement 212 into the fibers and pores of the mesh 902. In some embodiments, multiple distribution/depositing and compression stages are provided in alternating series (e.g., 2 or 3 sets of distribution/depositing and compression stages in series, etc.). In some implementations, the distribution and compression operations 20 may reduce a thickness of the cement 212 layer (e.g., a thickness of the cement 212 layer above the mesh 902). A series of brushes may be included between each compression stage to more evenly distribute the cement 212 across the mesh 902 and/or to clean an upper portion of the mesh 902 from cement 212. In an embodiment, finer brushes are used between later compression stages, resulting in an operation whose interaction with the cementitious composite (e.g., cement 212) is progressively reduced. For example, a first set of brushes, in between a first and second compression stage, may be configured to perturb a thickness of the mesh 902 that is greater than the thickness of the upper portion of the mesh 902, while a second set of brushes, in between a second and third compression stage, may be configured to clean (e.g., remove cement 212 from) only the upper portion of the mesh 902. In some embodiments, the manufacturing system 10 includes multiple compression and cement distribution systems 300 (e.g., after each cement dispensing device or system, etc.).

The method 5 of FIG. 1 further includes providing a permeable layer or fabric 1302, at 22, and joining the fabric 1302 with the mesh 902, at 24. As with the membrane 704 and the mesh 902, the fabric 1302 may be provided in a form of a bulk roll of material as shown in FIGS. 2-3, where the manufacturing system 10 is configured to supply the fabric 1302 from the roll at a predetermined rate to other subsystems in the manufacturing operation. Block 24 may include preparing the mesh 902 and/or the fabric 1302 for bonding and pressing the mesh 902 and the fabric 1302 together. In the embodiment of FIGS. 2-3, the manufacturing system 10 includes a heating system 400, a second adhesive application system 500, and a bonding and cutting system (not shown). The heating system 400 is configured to heat and soften/melt the upper portion of the mesh 902 for bonding. The heating system may be configured as a radiant heating system or another form of heating system. In some embodiments, the softening/melting of the upper portion of the mesh 902 is sufficient to provide suitable bond strength between the mesh 902 and the fabric 1302. In other embodiments, as shown in FIGS. 2-3, block 24 includes applying an adhesive to one, or a combination of, the mesh 902 and the fabric 1302. In yet other embodiments, the application of an adhesive alone may be provide sufficient bond strength between the mesh 902 and the fabric 1302. In other words, no softening/melting of the mesh 902 may be required to establish suitable bond strength between the mesh 902 and the fabric 1302. The second adhesive application system 500 of FIGS. 2-3 is configured to apply a layer of adhesive across a bottom surface of the fabric 1302, which is secured to the mesh 902 during a final bonding operation.

As shown in FIG. 1, the method 5 further includes winding and cutting the bonded cementitious material, at 26. The manufacturing system 10 of FIGS. 2-3 includes a winding system 600 configured to wrap the cementitious material in a roll about a central shaft. The rolls can be manufactured on cores of different diameters (e.g., 6 inches, 8 inches, 10 inches, etc.) and have a wide range of lengths (e.g., 5 ft-2,000 ft or more). The width of the rolls, perpendicular to a feed direction or roll direction (e.g., cementitious composites, mats, etc.) can vary within a range between approximately 0.2 ft and 40 ft or more. The thickness of the cementitious composite or mat can vary within a range between approximately 0.05 inches and 6 inches or more. The winding system 600 is configured to tension the cementitious material during the winding operation to maximize the quantity of cementitious material in a given winding (e.g., to remove any slack from the cementitious material during winding). In various exemplary embodiments, the manufacturing system includes at least one rotary encoder or another device configured to determine a rotational speed and/or position of rotating equipment. The rotary encoder may be mounted to a rotating guide wheel that contacts the moving cementitious composite as it moves along the production line. The rotary encoder may be used to determine a length of the cementitious composite and/or identify a trailing edge of the cementitious composite at the end of the production run. For example, the manufacturing system may include a rotary encoder mounted to or otherwise disposed on rotating guide wheels that contact the cementitious composite near the bias-cut conveyer. Similar rollers and/or sensors may be used to pick up the leading and/or trailing edge of the cementitious composite at the end of the production process before a final winding system. Alternatively, or in combination, the manufacturing system may include photoelectric sensors to detect progression of the cementitious composite through the production line (e.g., a location of the leading edge and/or trailing edge of the cementitious composite as is moves through the production line). The photoelectric sensors may be configured to pick up differences in an amount of reflected light to identify the edges of the cementitious composite. In an exemplary embodiment, at least one photoelectric sensor may be used to identify the trailing edge of the cementitious composite in order to accurately time the activation of equipment for the cutting and bonding system.

Although not shown in FIG. 1, the method 5 of making a cementitious material may further include a packaging operation where the winding is ejected from the winding system 600 and sealed or otherwise protected from an environment surrounding the winding using a non-permeable material (e.g., plastic or another suitable material that is vacuum formed onto the winding to prevent moisture from interacting with the cement 212). In embodiments where the roll is sealed (e.g., vacuum, etc.), a plastic material having high tensile strength and/or abrasion resistance properties may be used to resist wear from handling the rolls. In some embodiments, multiple layers of plastic can be used. In embodiments where multiple layers of material are used to package the roll, the layers may have different material properties. The plastic material may be provided to the manufacturing system in rolls, similar to the mesh, membrane, and fabric, and may include a core shaft and safety chuck setup to allow for safe and reliable re-loading of packaging material.

The vacuum sealing operation for the finished roll may be performed in multiple stages. For example, a first plastic material may be vacuum sealed over the roll, and a second, third, or fourth plastic material may be vacuum sealed over both the first plastic material and the roll. A label may be applied to the roll (e.g., to the plastic material that is wrapped around the roll, etc.). The label may be a sticker applied to the roll and/or the plastic material. In other embodiments, the label may be printed directly onto the roll. The manufacturing system 10 may include a labeling system configured to apply the label to the roll (e.g., an inkjet printing system, or any other labeling device). The roll may be supported by a crane (e.g., an overhead crane, a crane coupled to tracks on the ground, a forklift, etc.) during the packing operation. The crane may also be used to move material (e.g., rolls) to and from different areas of the manufacturing facility. For example, cranes may be used to pick up finished materials and move them to storage or shipping areas. Additionally, the cranes may be used to place new rolls of raw materials in position along the production line (e.g., to move the new rolls onto an unwinding system, a feed system, etc.).

The package may include a pull string, tear string, or seam that may be used to facilitate unpacking of the rolls (e.g., removal of the plastic packaging material from each roll, etc.). The pull string or other unpacking device may extend along the roll and may be manually placed over the roll or machine fed onto the roll before applying the plastic material to the roll. At least part of the pull string or other unpacking device may be exposed outside of the roll after packaging to facilitate identification of the pull string. In other embodiments, the pull string or other unpacking device may be manually placed or machine fed after packaging (e.g., by opening and resealing the plastic material, or by applying the pull string or other unpacking device to the roll after wrapping the roll but before the vacuum sealing operation, etc.).

In other embodiments, the cementitious composite may be packaged as a flat individual sheet (e.g., not as a roll) or as many sheets that are layered on top of one another. Such an arrangement is particularly advantageous in embodiments where a short length of cementitious composite is produced. As with the rolls, each flat sheet may be individually sealed (e.g., vacuum sealed, etc.) with a plastic material, layers of plastic material, or another material.

In some embodiments, the cementitious composite may be manufactured in reverse, with the fabric 1302 positioned first, the mesh 902 applied (e.g., attached) on top of the fabric 1302, and then the membrane 704 applied (e.g., attached) over the mesh 902. The orientation of the cementitious composite may be reversed before winding. In other embodiments, the orientation of cementitious composite during manufacturing, relative to a direction of gravity, may be different.

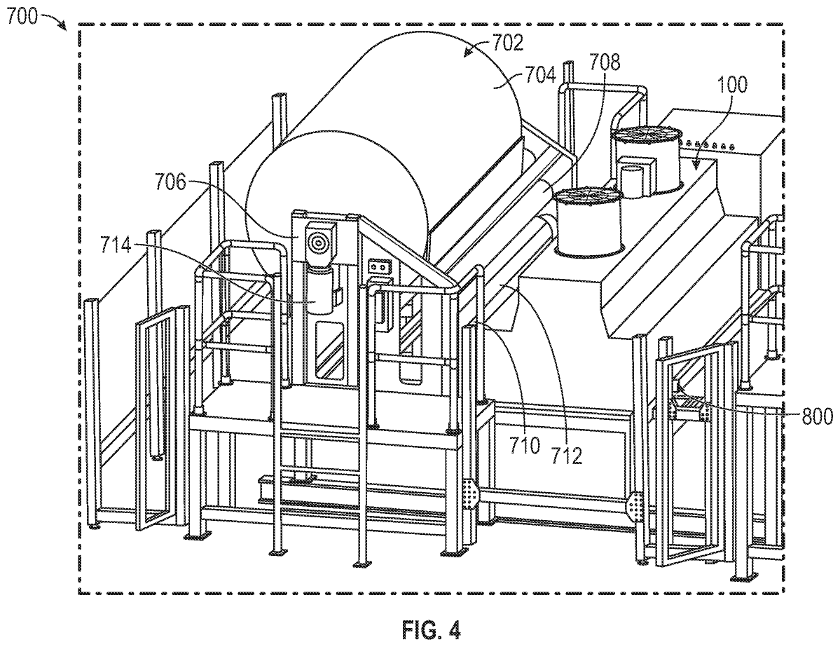

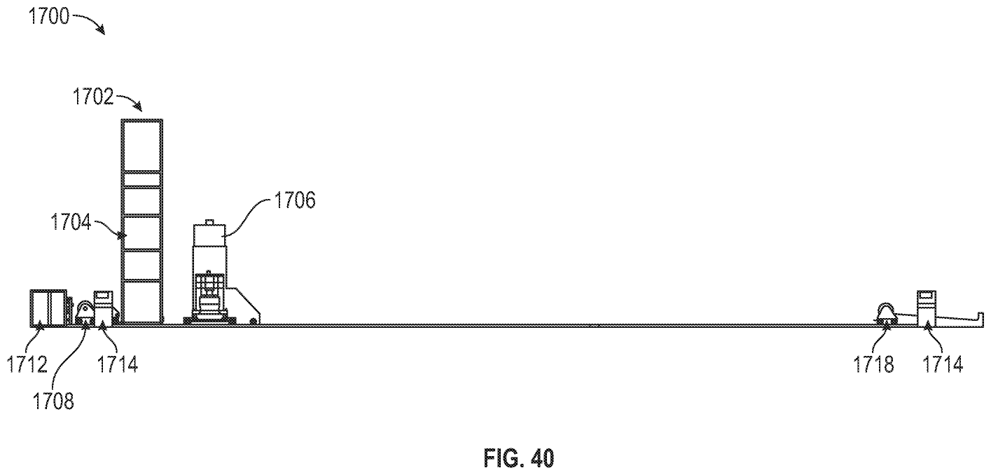

Motors may be included with different subsystems/modules to help move (e.g., feed) material. The motors may be fixed to rotating powered rollers between various stages or to rollers within different manufacturing stages. For example, the motors may be coupled to all the layer unwinding units or to compression rollers distributed along the manufacturing line. The details of the general depiction provided in FIGS. 1-3 will be more fully explained by reference to FIGS. 4-49.

A control system may be included to enable a user to control various subsystem operations described herein, including but not limited to unwind speed for each of the layers, layer tension, cement distribution rate, heater temperature, adhesive application rate, etc. These, among various other input parameters to the control system, may be specified by a user and/or operator of the manufacturing system 10 via a human-to-machine interface, shown as HMI interface 40 in the exemplary embodiment of FIG. 2. The HMI interface 40 may be remotely located from other system components a distance away from other components of the manufacturing system 10 to protect a user during normal operation. In various exemplary embodiments, the manufacturing system 10 includes an electrical enclosure (e.g., an electrical box, etc.) that houses the electrical equipment for the manufacturing system 10. The electrical equipment for the manufacturing system 10 may include, but is not limited to, power supplies, transformers, line reactors, electronic drives, and programmable logic controller components. The HMI interface 40 may also provide monitoring and/or diagnostic operations for the manufacturing system 10 (e.g., health monitoring such as if a roll of material becomes jammed or an adhesive dispensing spray nozzle becomes plugged; layer or cementitious material capacity monitoring, etc.) and may be configured to shut the system down in response to signals received from various sensors included on the manufacturing system 10. In other embodiments, other forms of computer programming controls systems may be used.

As shown in FIGS. 2-3, the manufacturing system 10 is subdivided in to modular subsystems 30. Each subsystem 30 includes its own individual support structure, allowing the system 10 to be rapidly reconfigured depending on the processing requirements for different cementitious composites. In the exemplary embodiment of FIGS. 2-3, each subsystem 30 occupies a length in a feed direction for the cementitious composite of no greater than 90 in. Among other benefits, the dimensions of each subsystem 30 allows each subsystem 30 to be individually packaged and shipped to an end user using ISO-standard shipping containers. The foregoing dimensions and others provided herein for the various exemplary embodiments are for example only and can be modified as needed to suit a variety of different cementitious material manufacturing applications.

In the exemplary embodiment of FIGS. 2-3, the manufacturing system 10 is configured to feed or otherwise transport the material in layers through a stationary equipment assembly. In other words, the layers of material are fed in sheets along rollers through stationary pieces of equipment. FIG. 4 shows an exemplary embodiment of an impermeable layer unwinding system, shown as membrane unwinding system 700, used in the manufacturing system 10 of FIGS. 2-3. The membrane unwinding system 700 includes a roll of impermeable (e.g., sealing, etc.) material, shown as roll 702. The roll 702 includes a core shaft (not shown) about which a membrane 704 is wound. In some embodiments, the core shaft includes an inflatable ballast (e.g., an inflatable structure within a hollow portion of the core shaft) that, once expanded, fixes the rotational position of the core shaft relative to the membrane 704 such that the membrane 704 can be rotated by rotating the core shaft. In various exemplary embodiments, the core shaft may weigh between 100 and 125 lbs. In other embodiments, the weight of the core shaft may differ. The core shaft is coupled to the unwinding system 700 via one or more safety chucks that secure the core shaft to a cradle on a support arm 706 on either side of the roll 702. The safety chucks allow for safe installation and removal of the bulk rolls of material. In some embodiments, the safety chucks are manually operated to guide the incoming roll onto the core shaft, and to operate the locking mechanism on the safety chucks that secures the core shaft to the safety chucks. The safety chucks may be designed to release the roll when a manual lever is positioned at a top-dead-center position or in another position that is easily observed by a laborer at a distance from the safety chucks. The visual indication prevents an undesirable condition where the safety chucks could disengage and drop a roll. In other embodiments, the safety chucks may be pneumatically operated (e.g., by an electrical signal from the HMI interface or from another control system for the machine). The safety chucks may be used for each of the input rolls and for the finished bulk roll of cementitious composite.

As shown in FIG. 4, the membrane 704 extends through a plurality of vertically aligned rollers including two idler rollers, shown as upper idler roller 708 and lower idler roller 710, as well as a load cell roller 712. The membrane 704 is at least partially wrapped around a load cell roller 712, which is disposed between the two idler rollers 708, 710. The load cell roller 712 includes a load cell that is configured to measure a force indicative of a tension on the membrane 704. In the embodiment of FIG. 4, the load cell is configured to measure a longitudinal force on the load cell roller 712 (e.g., a force oriented perpendicular to a primary axis of the load cell roller 712). In other embodiments, the load cell is configured to measure a resistive torque on the load cell roller 712 or another variable indicative of the tension on the membrane 704. The load cell measurement is provided as a feedback parameter to a control system for a roller motor 714. In various embodiments, the control system is also configured to vary the rotational speed of the roller motor 714 and thereby meter the rate of delivery of the membrane 704 to other subsystems. In some embodiments, the control system is an electronic drive capable of directly controlling the torque of an unwind motor. In some embodiments, the unwinding system includes a motor (e.g., the unwind motor) directly or indirectly coupled to the core shaft and configured to meter a feed rate of the membrane 704. In various exemplary embodiments, the membrane unwinding system 700 further includes a sensor configured to monitor a quantity of membrane 704 remaining on the roll 702 (e.g., an ultrasonic position sensor configured to monitor a diameter of the roll 702, etc.).

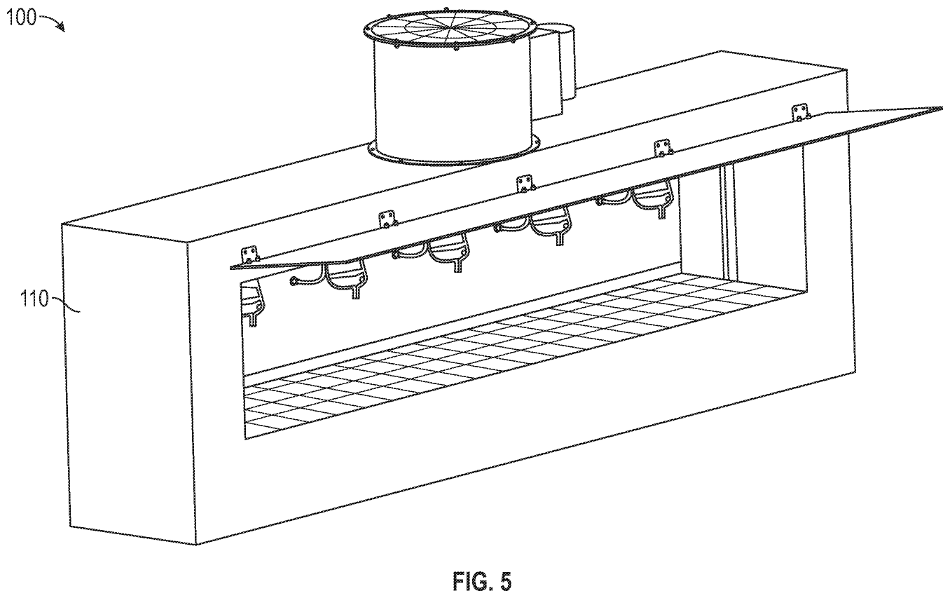

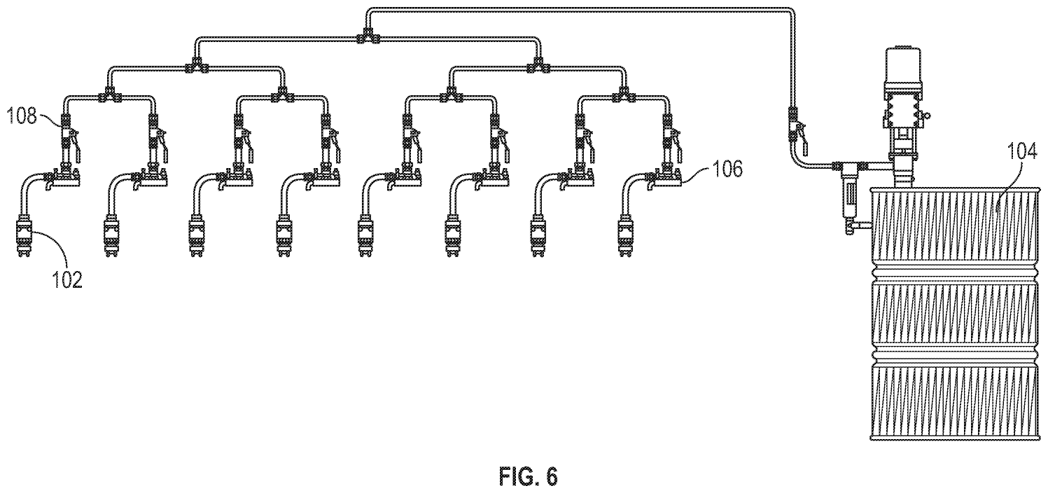

After passing through the vertically aligned rollers, the membrane 704 passes through a first adhesive application system 100. The adhesive application system 100 may be one of a variety of different systems configured to apply a layer of adhesive to a top surface of the membrane 704. For example, the adhesive application system 100 may be configured to apply a film of hot melt (e.g., a glue introduced to the system in solid form and dispensed as a liquid through one or more heated nozzles) to the membrane 704 or configured to extrude adhesive onto the mesh 902. Alternatively, the adhesive application system 100 may be configured to dispense an aerosolized adhesive or any other suitable bonding agent to the membrane 704. An exemplary embodiment of an aerosolized adhesive application system 100 is shown in FIG. 5. The aerosolized adhesive is distributed through a series of spray nozzles 102 spaced evenly above the membrane 704 as the membrane 704 passes beneath the spray nozzles 102. As shown in FIG. 6, adhesive is provided to the nozzles 102 arranged across a width of the membrane 704 by a pump 104 coupled to a large receiving tank (e.g., a 50 gal drum of adhesive, etc.). The receiving tank, or other adhesive storage container, may be stored in an airtight cabinet such as cabinet 501 shown in FIGS. 2-3 to protect the receiving tank from sparks (e.g., generated by electrical components, static electricity, etc.). Flow of adhesive from the pump 104 is distributed through a fluid conduit that extends between the pump 104 and each one of the plurality of nozzles 102. The adhesive application system further includes a plurality of flow regulators 106, each coupled to the fluid conduit upstream of a respective one of the plurality of nozzles 102 to ensure the flow of adhesive is uniformly distributed between each nozzle 102. In some embodiments, the adhesive application system 100 further includes a plurality of flow valves (e.g., ball valves, etc.) 108, each flow valve 108 is manually operable to selectively control the flow rate of adhesive through a respective one of the nozzles 102. In other embodiments, each flow valve 108 may be automatically controlled (e.g., by the HMI interface 40, etc.).

As shown in FIG. 5, the aerosolized adhesive application system 100 includes a fume hood 110 (e.g., gas extraction hood) to mitigate safety risks associated with the application of the adhesive. The fume hood 110 includes multiple interior compartments, configured to catch the fumes from the adhesive application process. In the embodiment of FIG. 5, the adhesive application system 100 includes two compartments, a primary chamber 112 over a main spray/extrusion area and a secondary chamber 114 outside of the main area. The fume hood 110 may additionally include a fan or other mechanism configured to facilitate removal of the air from the fume hood 110 and to an exterior of a building.

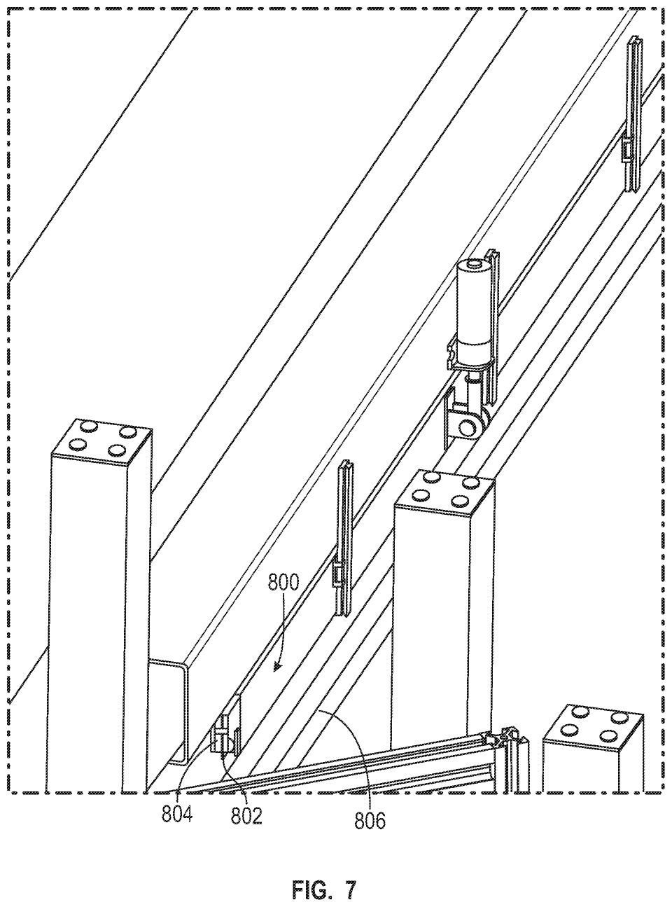

As shown in FIG. 4, after passing through the adhesive application system 100 the membrane 704 is routed past a membrane cutting system 800, which is configured to separate a piece of membrane 704 from the roll 702 (e.g., at the end of a process run, etc.). An exemplary embodiment of the membrane cutting system 800 is shown in FIG. 7. The membrane cutting system 800 includes a pneumatically actuated blade 802 supported by two heated bars 804, one on either side of the blade 802. The blade 802 is “sandwiched” or otherwise disposed between the two heated bars 804 and is at least partially supported by the heated bars 804. The heated bars 804 are configured to heat the blade 802, which simplifies the cutting operation in some implementations (e.g., to produce a cleaner cut edge, to reduce fraying or the risk of a partial cut, etc.). In other embodiments, the membrane cutting system 800 may include at least one blade without heated bars 804. The blade may be drawn across the material or pinch down upon the material to cut through the layers. In the embodiment of FIG. 7, the membrane cutting system 800 also includes a cutting support 806, which supports the reverse side of the membrane 704 throughout the cutting operation. The cutting support 806 is a lower plate or surface that includes a slot sized to receive the blade 802 therein.

As shown in FIGS. 2-3, the membrane 704 including the adhesive layer is routed to a structure layer unwinding system, shown as mesh unwinding system 900. The mesh unwinding system 900 includes a roll of mesh 902, shown as roll 904, that is supported and controlled using mechanisms that are similar to those implemented for the membrane unwinding system 700 shown in FIG. 4.

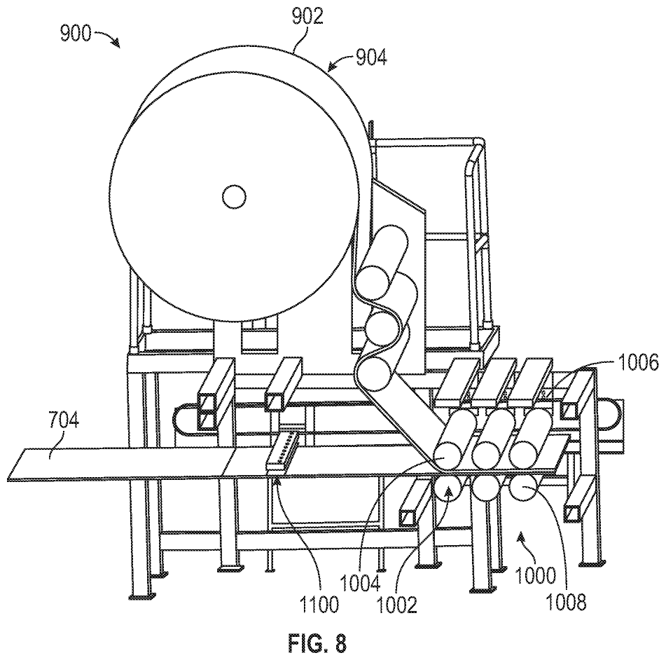

As shown in FIG. 8, the mesh 902 is fed through a series of vertically aligned rollers (e.g., pairs of diametrically opposed rollers) configured to control the tension on the mesh 902 before passing the mesh 902 through a first compression system 1000. In alternative embodiments, the rollers may be horizontally aligned with the mesh 902 fed vertically through the rollers or arranged in another orientation. In the exemplary embodiment of FIG. 8, the first compression system 1000 includes three pairs of rollers 1002 configured to compress the membrane 704 and the mesh 902 together. A top roller 1004 of each pair of rollers 1002 includes a pneumatic actuator 1006 that is configured to push the top roller 1004 toward a lower roller 1008 of each pair of rollers 1002, thereby increasing the bond strength of the adhesive joint. The lower roller 1008 of each pair of rollers 1002 is configured to pull the layers through the first compression system 1000. In other words, the lower roller 1008 of each pair of rollers 1002 is configured to apply tension to the layers. In the embodiment of FIG. 4, one or more of the lower rollers 1008 is belt driven by a single motor (or belt driven by another one of the lower rollers 1008). In other embodiments, one or more of the lower rollers 1008 may be directly coupled to the shaft of a motor.

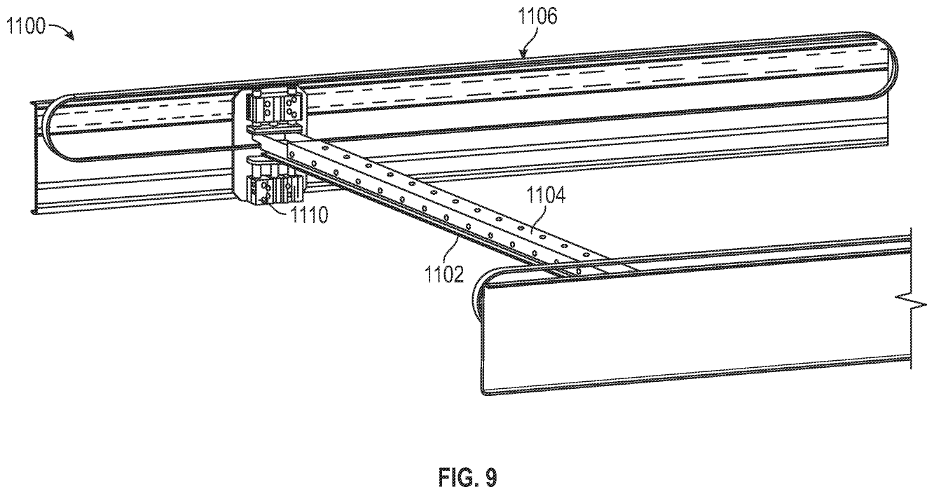

The manufacturing system 10 of FIGS. 2-3 includes a pre-feeding system for both the membrane 704 and the mesh 902. An exemplary embodiment of a pre-feeding system for the membrane 704, shown as pre-feeding system 1100, is shown in FIG. 9. The pre-feeding system 1100 includes a plate 1102 and an upper bar 1104 that each extend across a region where the membrane 704 is located (e.g., in a direction that is perpendicular to the feed direction). The upper bar 1104 is oriented substantially parallel to the plate 1102 and is disposed just above the plate 1102 (e.g., vertically above). The plate 1102 and the upper bar 1104 are coupled at each end to a pulley system 1106 configured to reposition the plate 1102 and the upper bar 1104 along the feed direction for the membrane 704. The plate 1102 and the upper bar 1104 are reconfigurable between an open position, where the plate 1102 and the upper bar 1104 are separated, and a closed position, where the plate 1102 and the upper bar 1104 are closed together. A pair of pneumatic actuators 1110 is disposed on either end of the plate 1102 and the upper bar 1104. During normal operation, an operator may manually feed a length of membrane 704 in between the plate 1102 and the upper bar 1104. The pneumatic actuators 1110 are then activated, forcing the plate 1102 and the upper bar 1104 together and sandwiching the membrane 704 therebetween. The upper bar 1104 further includes a plurality of electromagnets disposed along a length of the upper bar 1104, which, once activated, compress a central portion of the plate 1102 (e.g., a thin strip of magnetic material such as iron, steel, etc.) against the upper bar 1104. Among other benefits, the electromagnets ensure that an approximately even force is applied to the membrane 704 across the width of the membrane 704 to thereby ensure that an equal tension is applied across the width of the membrane 704.

The pulley system 1106 is configured to activate once the membrane 704 is secured between the plate 1102 and the upper bar 1104. The pulley system 1106 pulls the membrane 704 through a gap formed between each of the three pairs of rollers 1002. At the far end of the pulley system the pneumatic actuators 1110 may be retracted, separating the plate 1102 from the upper bar 1104. A similar pre-feeding system may be used to pull the mesh 902 through the gap between each of the three pairs of rollers 1002. Alternatively, an operator may manually pre-feed the mesh 902 through the rollers 1002, either before the membrane 704 is pulled through (e.g., the operator could lock the mesh 902 in place using clamping bars/plates that are actuated automatically or using a manual clamping device such as a C-clamp) or after the membrane 704 is pulled through. In the latter scenario, the operator could simply activate the pneumatic actuator 1006 for one or more of the three pairs of rollers 1002 together to secure the mesh 902 in position and start the processing operation (e.g., the compressing operation to join the mesh 902 to the membrane 704).

In some exemplary embodiments, the manufacturing system 10 additionally includes a back-end attachment device (not shown) disposed between the unwinding systems for the mesh/membrane and the cement supply and dispensing system 200. The back-end attachment device is configured to apply process tooling to the back-end of the process batch (e.g., at a leading edge of the mesh, to fully secure the cut end of the mesh to the membrane). The back-end attachment device may compress the joined membrane and mesh together between the process tooling (e.g., an upper rectangular bar and a lower rectangular bar that extend across a width of the mesh). Among other benefits, the process tooling masks the leading edge of the mesh (e.g., where the mesh joins with the membrane), and provides a sharp and accurate mix-fill edge at the leading edge of the cementitious composite. In some embodiments, the back-end attachment device may include a sensor that is used to determine the presence of the mesh on the membrane in order to accurately time the activation of pneumatic actuators that are used to press the process tooling against the mesh and the membrane.

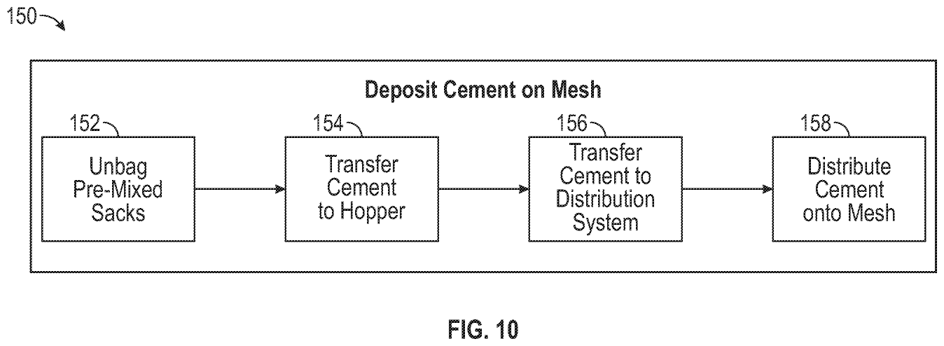

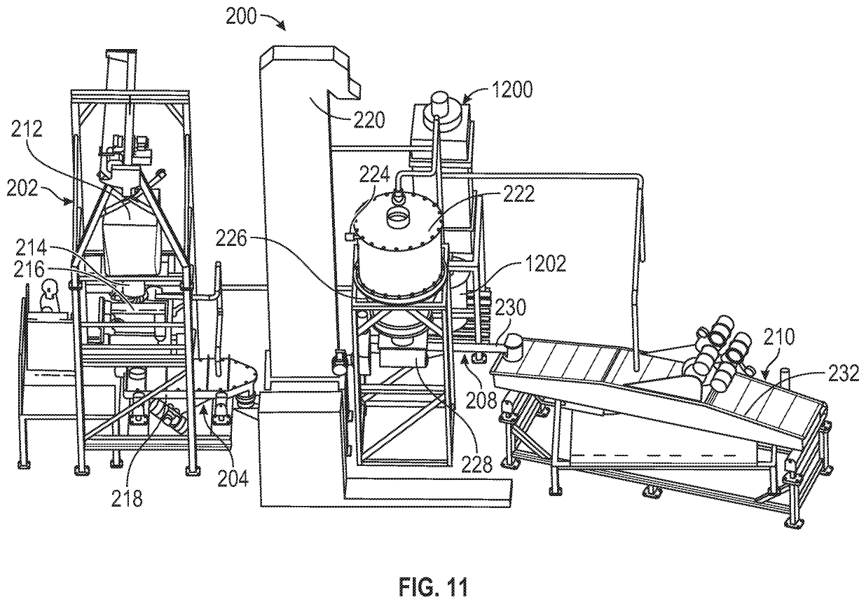

As shown in FIGS. 2-3, after passing through the first compression system 1000 the bonded layers (membrane 704 and mesh 902) are routed through a cement supply and dispensing system 200, which is configured to deposit a layer of cementitious material, referred to herein as cement, to a top surface of the mesh 902. A method 150 of depositing the cement 212 to the mesh 902 is shown in FIG. 10. The method 150 includes i) unbagging pre-mixed sacks of cement 212, at 152; ii) transferring the cement 212 to an intermediate hopper, shown as hopper 222, at 154; iii) transferring the cement 212 to a distribution system 210, at 156, and iv) distributing the cement 212 onto the mesh 902, at 158. Note that in other embodiments, the distribution system 210 (e.g., a bias-cut conveyer as will be further described or other cement distribution apparatus) may be configured to receive cement 212 directly from a bulk silo or from a hopper that is configured to receive cement from a bulk silo. In other embodiments, the distribution system 210 may be configured to receive cement from a mixer or a silo/hopper on a vehicle. An exemplary embodiment of the cement supply and dispensing system 200 is shown in FIG. 11. The cement supply and dispensing system 200 includes an unbagging system 202, a bag-to-hopper transfer system 204, a hopper 222, a hopper-to-dispenser transfer system 208, and a cement distribution system 210.

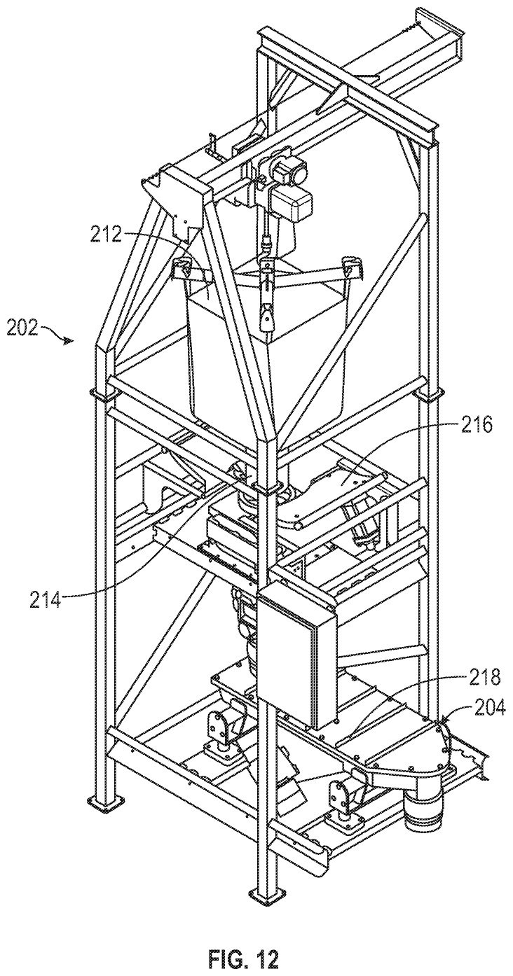

An exemplary embodiment of the unbagging system 202 is shown in FIG. 12. The unbagging system 202 is configured to unbag the pre-mixed sacks 213 of cement 212. In operation, a user loads an individual sack 213 of cement 212 onto a hoist (e.g., overhead crane, etc.), which is configured to support the sack 213 of cement 212 above a control valve 214 for the unbagging system 202. The user loads the sack 213 by manually attaching a rigging harness to the top of the sack 213 from a side of the unbagging system 202. The hoist then lifts the sack 213 and transports the sack 213 in a lateral direction to a region that is centered above the control valve 214. The hoist then lowers the sack 213 over top of the control valve 214. The control valve 214 is configured to be in fluid receiving communication with the sack of cement 212 such that it may receive and direct the flow of cement 212 from the sack. To empty the sack of cement 212, a user unties the sack 213 and opens the control valve 214. The user may access the sack 213 using, for example, a scissor lift (not shown) and/or stairwell positioned along the side of the unbagging system 202. The control valve 214 may include a gate valve and may be coupled to the HMI interface (not shown) or another control system. The HMI interface may operate the gate valve to empty the sack 213 at a desired rate into a hopper that is positioned below the gate valve.

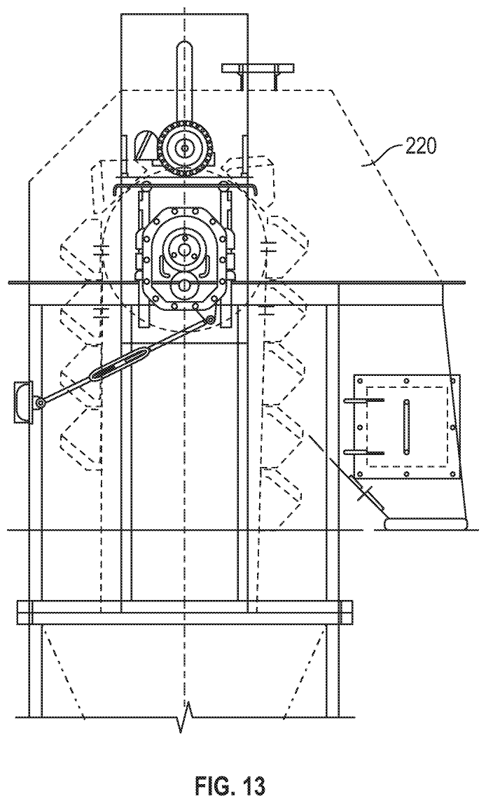

To facilitate emptying of the sack 213, the unbagging system 202 additionally includes a pair of messaging paddles 216 configured to manipulate a portion of the sack 213 and thereby promote the release of any cement trapped along an edge of the sack 213 or in a lower corner of the sack 213. In the exemplary embodiment of FIG. 12, the messaging paddles 216 are pneumatically actuated plates that press against a lower portion of the sack 213 to agitate the cement 212 within the sack 213. The released cement is received by a vibratory discharge conveyer system 218 (e.g., part of the bag-to-hopper transfer system) that is coupled to a bucket elevator 220. The vibratory discharge conveyer system 218 provides a flow of cement that is approximately evenly distributed across a width of each bucket in the bucket elevator 220. In other words, cement received by the vibratory discharge conveyer system 218 is distributed approximately uniformly across a width of the conveyor due to the vibratory movement of the conveyor. The bucket elevator 220 receives the cement from the vibratory discharge conveyer system 218 into one of a plurality of buckets 219, which are moved vertically upwardly through the bucket elevator 220. A top portion near a discharge to the bucket elevator 220 is shown in FIG. 13. A discharge to the bucket elevator 220 is disposed above a hopper 222, which is coupled via a tube (not shown) to the bucket elevator 220. In operation, the cement 212 drops from the bucket elevator 220 (e.g., from each bucket 219 as it passes a highest point of the bucket elevator 220), through the tube, and into the hopper 222. The hopper 222 is configured to hold enough cement for at least one processing run (e.g., one full length of cementitious composite), which advantageously, eliminates the need for performing bag unloading operations while the bonded layers are moving through the stationary equipment. In some embodiments, the hopper 222 is refilled during the dispensing/depositing/unloading operation.

The hopper 222 shown in FIG. 11 is configured to hold between 3000 lbs. and 5000 lbs. of cement, although the capacity of the hopper 222 may vary depending on the required production volume of the cementitious composite. The hopper 222 includes two level sensors configured to report the height of the cement in the hopper 222 and report the measurement to the control system. In an exemplary embodiment, a high level sensor 224 is configured to provide the control system with an indication that the level of cement is sufficient for at least one processing run, while a low level sensor 226 is configured to either alert a user of a low level condition or to signal the control system to shut down the manufacturing system in case an amount of cement drops below a predefined threshold value. In an exemplary embodiment, the high level sensor 224 is configured to provide an indication to the control system to begin a manufacturing operation (e.g., to provide an indication that enough cement has been received within the hopper 222 to complete at least one processing run of cementitious composite).

As shown in FIG. 11, the hopper 222 is coupled to a hopper-to-dispenser transfer system 208 that is configured to provide a metered quantity of cement to a distribution system 210. The hopper-to-dispenser transfer system 208 includes a vibratory bin discharger 228 configured to shake the cement out of the hopper 222 and into a cement feeder, shown as feeder 230. Among other benefits the vibratory bin discharger 228 substantially prevents the cement from becoming clogged within a lower portion (e.g., narrow portion) of the hopper 222. The feeder 230 receives the cement mixture from the vibratory bin discharger 228. In the embodiment of FIG. 11, the feeder 230 is a volumetric screw feeder, although any other suitably accurate flow metering and delivery device may be used. In some implementations, the feeder 230 is controlled (e.g., speed controlled, etc.) automatically by the control system to scale the rate of cement delivery based on a processing speed for the manufacturing system 10 (e.g., a roll unwind speed for the membrane and mesh, etc.). In particular, an electronic drive may be used to vary a rotational speed of the feeder 230 in order to control the volumetric flow rate of cement. In various exemplary embodiments, the feeder 230 additionally includes a rotary encoder coupled to a screw shaft for the feeder 230 and configured to determine a rotational speed of the screw shaft and/or other operational parameters for the feeder 230.

The distribution system 210 includes a housing 232 defining an inner chamber into which the cement (not shown) is received. The housing 232 forms part of a bias-cut conveyer for the distribution system 210 which is configured to provide even spreading and application of cement onto the mesh and membrane (e.g., receiving material). The housing 232 is coupled to a vibrator, which perturbs the housing 232 to ensure an approximately uniform thickness of cement is maintained across the lower surface of the housing 232. According to an exemplary embodiment, the housing 232 sits on vibration isolation dampers and is mounted to a sub-frame structure that is separate from other parts of the distribution system 210. Among other benefits, the vibration isolation dampers isolate any vibrations produced by the distribution system 210 and thereby lower the risk of exported vibrations to the surrounding equipment.

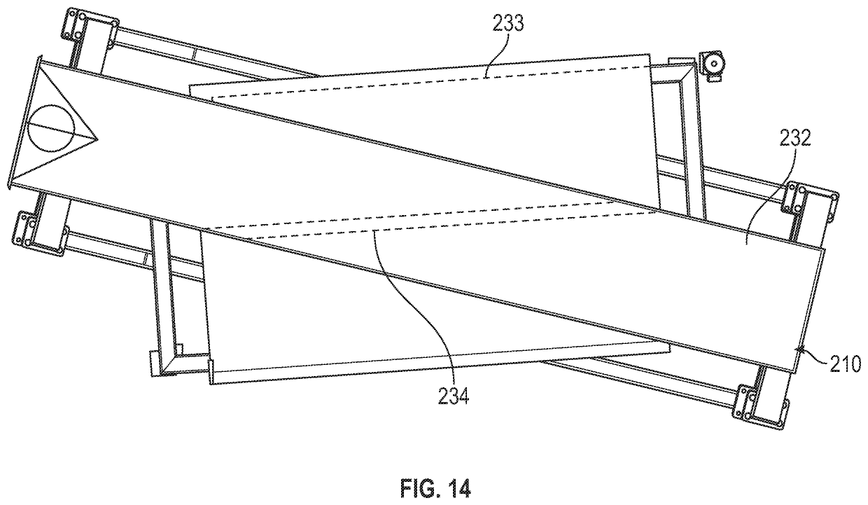

The cement is distributed from the housing 232 onto a top surface of the mesh (not shown), which is at least partially supported by a smooth surface or conveyor 233 below the housing 232. FIG. 14 shows the housing 232 for the distribution system 210 at a cross-section through a top wall of the housing 232, according to an exemplary embodiment. As shown in FIG. 14, the housing 232 is oriented at an oblique angle relative to the conveyer (i.e., relative to the feed direction). In other words, the housing 232 is non-parallel and non-perpendicular to the conveyer (e.g., the feed direction). The housing 232 includes a slot 234 disposed in a bottom wall of the housing 232. The slot 234 extends in a substantially perpendicular orientation relative to the feed direction for the mesh and the membrane (not shown), such that the slot 234 is biased with respect to the housing 232. The arrangement of the slot 234 relative to the housing 232 allows the cement to be distributed approximately evenly across the width of the mesh as it passes along the conveyor 233 beneath the slot 234.

In various exemplary embodiments, the distribution system 210 additionally includes at least one load cell mounted to the conveyor 233. The load cell is configured to measure the weight of the receiving material along a portion of the production line where the cement is dispensed. The load cell data may be utilized by the HMI interface or another control system to determine an amount of cement powder being applied to the mesh (e.g., a volumetric flow rate of cement, etc.).

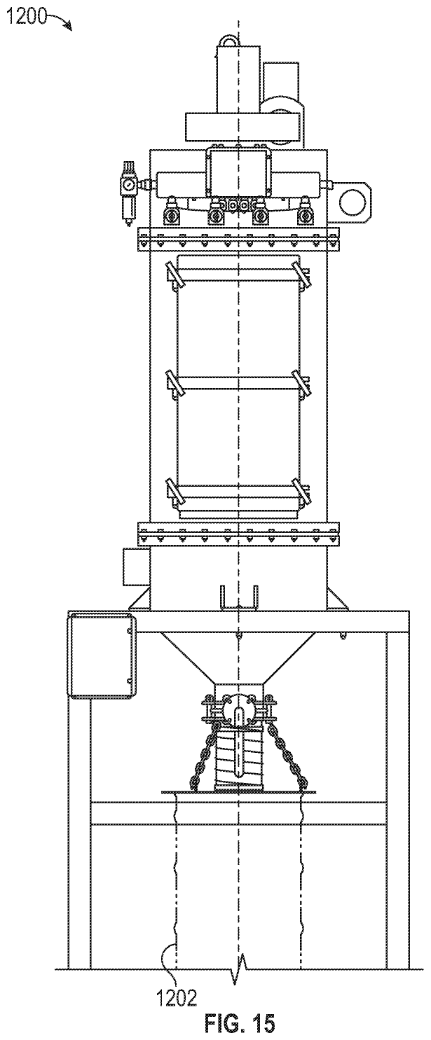

FIG. 11 also shows a dust extraction system 1200 configured to pull dust generated by the cement supply and dispensing system 200. FIG. 15 shows a receiving unit and collection container 1202 for the dust extraction system 1200 (see also collector bin 1201 shown in FIG. 3). As shown in FIGS. 12 and 15, any dust generated within the hopper 222, the housing 232, and other cement transfer systems is extracted through tubes that connect to the collection container 1202, which is disposed toward the bottom of the dust extraction system 1200. The collection container 1202 may be emptied periodically between production runs. In other embodiments, cement dispensing and distribution operations may be performed without a dust extraction system. The cement supply and dispensing system 200 may additionally incorporate shielding, brushes, and other suitable containment features to prevent cement dust from being generated or released to the surroundings. In various exemplary embodiments, the manufacturing system includes an air compressor, which is used to operate various pieces of machinery such as pneumatic actuators, the dust extraction system 1200, and others.

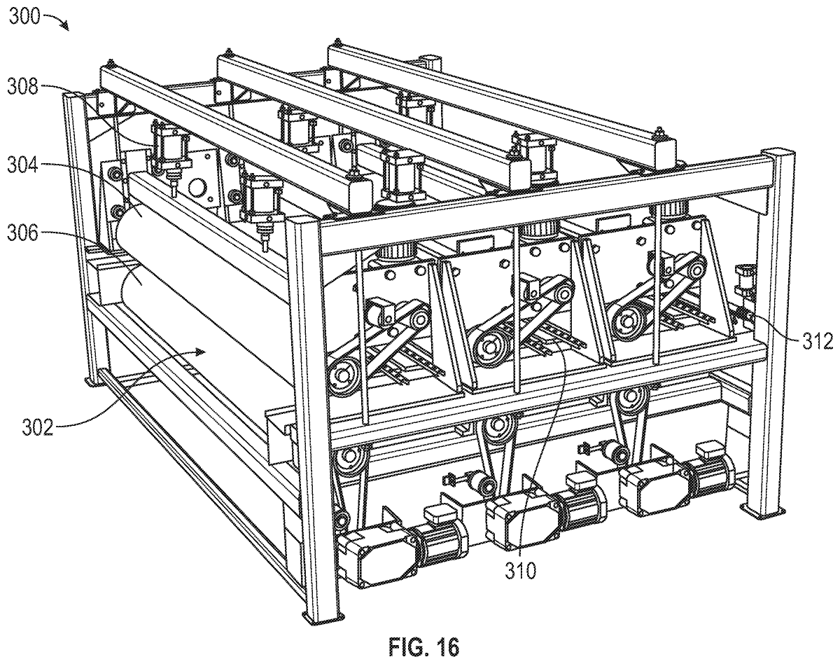

As shown in FIGS. 2-3, after receiving cement 212, the mesh 902 and membrane 704 are routed to a compression and cement distribution system 300, which is shown according to an exemplary embodiment in FIG. 16. Similar to the first compression system 1000, the compression and cement distribution system 300 includes three pairs of vertically aligned rollers 302 spaced evenly along the feed direction, although more or fewer pairs may be included depending on processing requirements. As shown in FIG. 16, each pair of rollers 302 includes two diametrically opposed rollers including an upper roller 304 and a lower roller 306. Each upper roller 304 is coupled to an upper cross-arm of the compression and cement distribution system 300 by an actuator, shown as pneumatic actuator 308, which is configured to apply a predetermined force on the upper roller 304 and thereby press the cement into the mesh (not shown). More or fewer pneumatic actuators 308 may be includes in various exemplary embodiments. In some embodiments, each of the pneumatic actuators 308 is configured to apply a force upwards of 2500 lbs. or greater to the upper roller 304. The force applied by the pneumatic actuators 308 to the upper roller 304 may be adjusted using a pressure regulating valve upstream of the pneumatic actuator 308, between the pneumatic actuator 308 and a pressure source (e.g., an air compressor). In the embodiment of FIG. 16, each of the upper rollers 304 and lower rollers 306 is belt driven and includes a belt tensioning mechanism configured to automatically adjust the belt tension depending on a position of the rollers 304, 306 as well as the force being applied by the rollers 304, 306 to the mesh (e.g., the force applied to compress the rollers 304, 306 together). In some embodiments, each pair of vertically aligned rollers 302 includes an electronic height gauge, which may be used to determine the compression height of the cement and the gap size between the top of the mesh and the fabric (e.g., a thickness of the cement above the mesh, etc.).

A series of brushes 310 is positioned between each adjacent pair of rollers 302. The brushes 310 may be made from nylon or any other suitable material. The brushes 310 are configured to scrape the deposited cement (not shown) along an upper portion of the mesh to more evenly distribute and fill the cement into the mesh. In the embodiment of FIG. 16, there exists a pair of brushes 310 between each adjacent pair of rollers 302, although more or fewer brushes 310 may be used between each pair of rollers 302 depending on processing requirements. Each of the brushes 310 is height adjustable, which enables the operation to be carried out in stages. Furthermore, the brushes 310 adjacent to earlier pairs of rollers 302 may be coarser than brushes 310 used after later compression stages, resulting in an operation whose interaction (e.g., penetration depth of the brushes into the mesh, force applied by the brushes 310 on the mesh, etc.) with the mesh is progressively reduced.

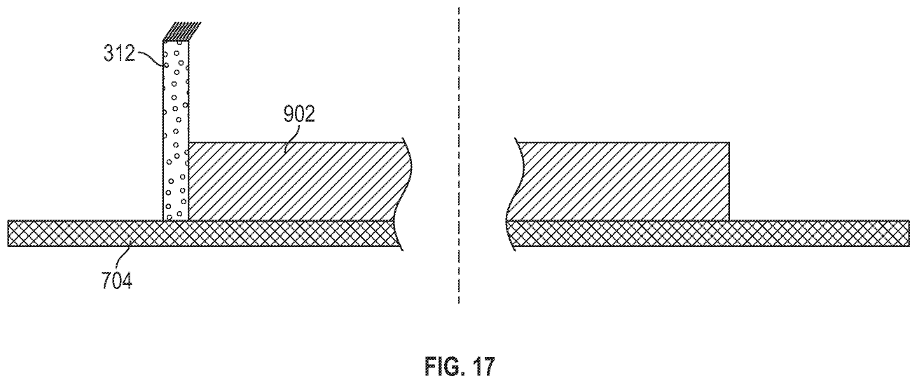

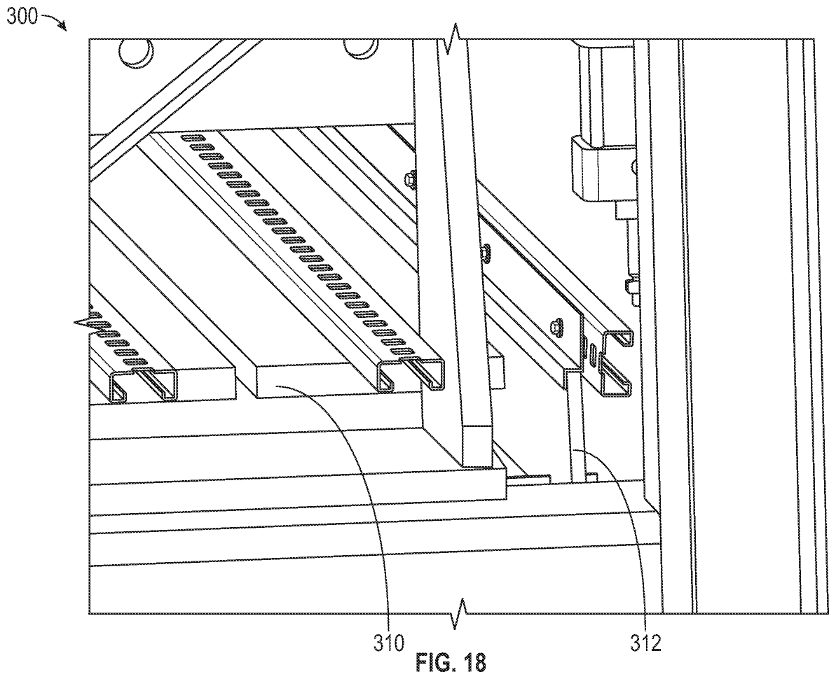

In some implementations, the membrane 704 may extend beyond the mesh 902 proximate to a trailing edge of the cementitious composite. Such a layering arrangement is shown in FIG. 17, according to an exemplary embodiment. To prevent the buildup of cement within this small section of membrane 704, the compression and cement distribution system 300 may include a height adjustable scraper, shown as scraper 312 (see also FIG. 18), configured to remove any residual cement from the trailing edge and/or side edges of the membrane 704. For example, the compression and cement distribution system 300 may be configured to lower the scraper 312 near an end of a production run, as the trailing edge of the membrane 704 passes the scraper 312, to remove any buildup of cement from the upper surface of the membrane 704 in this region. The compression and cement distribution system 300 may be configured to raise the scraper 312 before beginning another production run.

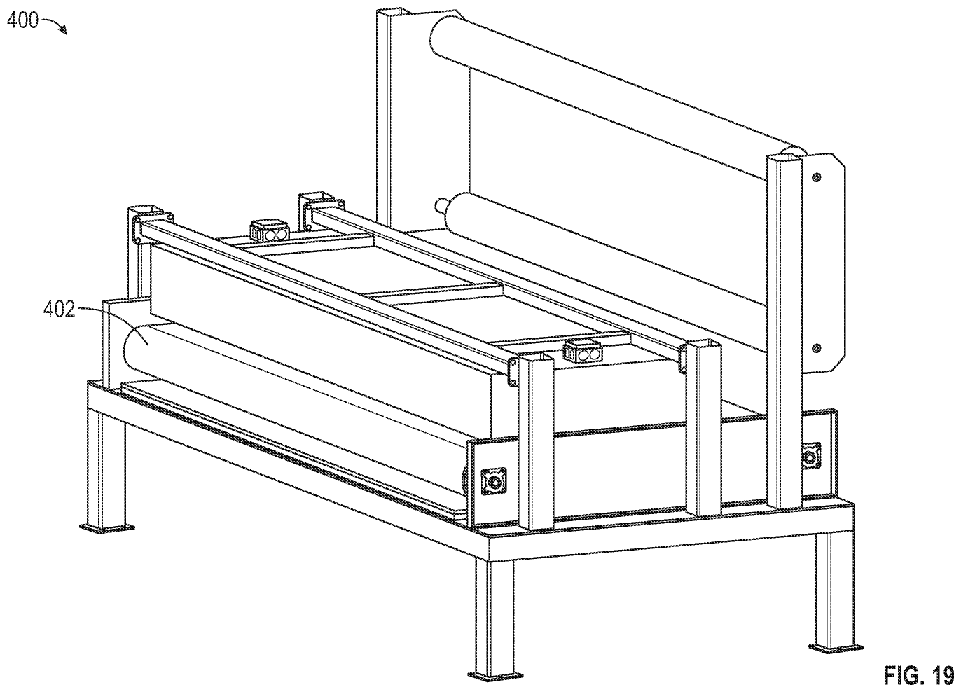

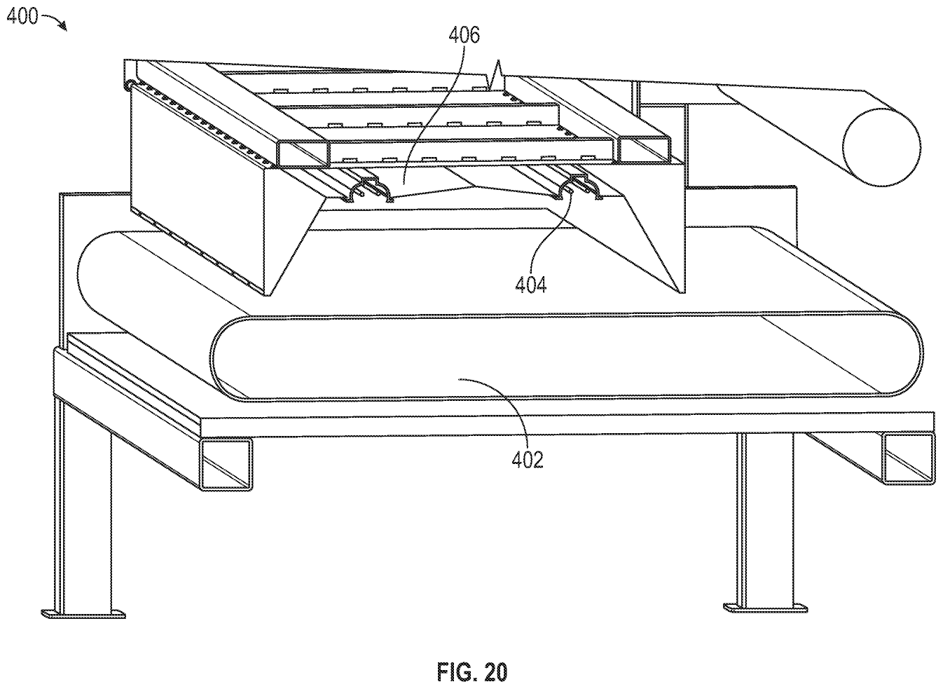

Returning again to FIGS. 2-3, after passing through the compression and cement distribution system 300, the mesh 902 is routed through a heating system 400 configured to soften/melt the upper portion of the mesh before a final joining operation. An exemplary embodiment of the heating system 400 is shown in FIGS. 19-20. The heating system 400 is configured as a radiant heating system that includes a heat resistant conveyer 402, radiant heating elements 404, and heat shielding 406. In some embodiments, the heating system 400 also includes a fume hood (e.g., gas extraction hood above the heated area) to remove fumes generated during heating. The heat resistant conveyer 402 is configured to support and direct the cement, mesh 902, and membrane 704 (see also FIGS. 2-3) as they pass beneath the radiant heating elements 404. The heat shielding 406 is configured to direct heat from the radiant heating elements 404 toward the mesh 902 in sufficient quantity to melt an upper portion of the mesh 902. According to an exemplar embodiment, the heating elements 404 and/or heat shielding 406 is height adjustable, such that a vertical distance between the heating elements 404 and the heat resistant conveyer 402 may be modified to vary the amount of heating provided to the mesh 902 without changing the amount of power provided to the heating elements 404. The heating system 400 may additionally include a temperature sensor and/or other process management sensors to ensure that the heating system 400 remains within prescribed operational limits and/or to enable feedback control of the heating system 400 via the HMI interface (not shown). In the exemplary embodiment of FIGS. 19-20, the radiant heating elements 404 are configured to operate within a range of temperatures between 800° F. and 1000° F. In alternative embodiments, the radiant heating elements 404 may be replaced with another form of heater. For example, the mesh 902 may be heated by passing the mesh 902 through an oven. In other embodiments, a blow torch, laser, or heated contact element (e.g., heated plate that contacts the mesh 902) may be used to soften the mesh 902. In yet other embodiments, at least one laser may be used to heat and soften the mesh 902 for bonding. The operating temperature range of the heaters may also vary depending on the processing requirements and the types of materials used for the mesh 902.

A final joining operation for the manufacturing system 10 of FIGS. 2-3 includes providing a permeable layer or fabric to the cementitious composite to encase the cement within the mesh 902. In some embodiments, a paint or other spray treatment may be applied to the fabric to facilitate joining of the fabric to the mesh. In some implementations, the operation of melting the upper portion of the mesh 902, as depicted in FIGS. 19-20, may be sufficient to achieve suitable bond strength between the fabric and the upper portion of the mesh 902. In other embodiments, different or additional processing operations (e.g., adhesive application, etc.) are required to establish suitable bond strength. In the exemplary embodiment of FIGS. 2-3, the manufacturing system 10 includes a second adhesive application system 500 configured to apply a layer of adhesive to a mesh facing side of the fabric. In other embodiments, the second adhesive application system 500 may be configured to apply adhesive to an upper surface of the mesh 902 (e.g., a fabric facing side of the mesh, etc.) rather than the fabric. In some embodiments, the adhesive may be applied to the fabric and/or mesh 902 using a roller or a brush instead of being sprayed from a distance.

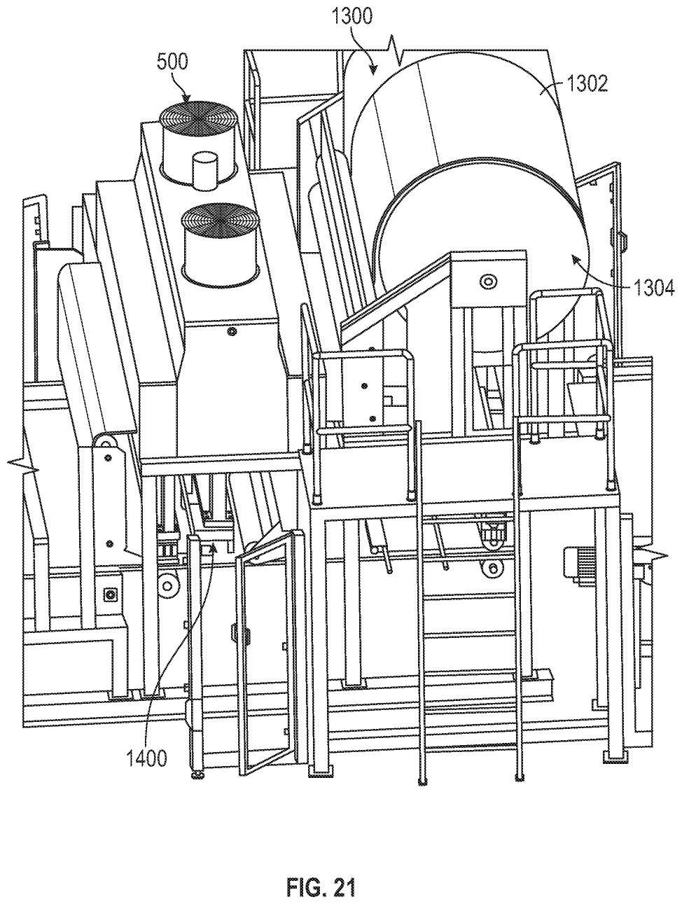

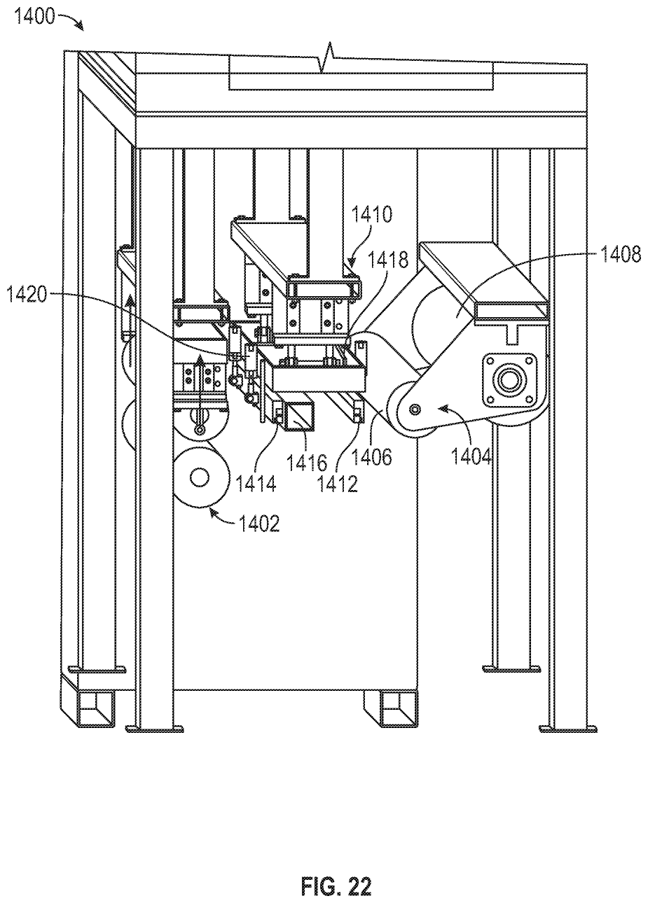

The second adhesive application system 500 is shown along with a fabric unwinding system 1300 in FIG. 21. The fabric unwinding system 1300 is configured substantially similar to the membrane unwinding system 700 of FIG. 4. The fabric, shown as fabric 1302, is provided in the form of a fabric roll, shown as roll 1304. The fabric 1302 is routed from the roll 1304 through the second adhesive application system 500, which applies an adhesive product to the mesh facing surface of the fabric 1302. The fabric 1302 is then routed from the second adhesive application system 500 toward a final bonding and cutting system, shown according to an exemplary embodiment as bonding and cutting system 1400 in FIG. 22.

As shown in FIG. 22, the bonding and cutting system 1400 includes a pair of vertically aligned compression rollers 1402 and rotary feed system 1404. The rotary feed system 1404 is utilized at the beginning of the cementitious composite manufacturing process. Specifically, the rotary feed system 1404 is configured to pre-feed the fabric 1302 through a gap between the compression rollers 1402 and to support the fabric 1302 within the gap prior to bonding. As shown in FIG. 22, the rotary feed system 1404 includes an idle roller 1406, which is configured as a guide for the fabric 1302, and a motor driven roller 1408, which is configured to take up any initial slack in the fabric 1302 prior to the bonding operation. The motor driven roller 1408 is disposed farther from the vertically aligned compression rollers 1402 than the idle roller 1406, in the feed direction. The motor driven roller 1408 has a larger diameter than the idle roller 1406. In other embodiments, the size and arrangement of the idle roller 1406 and the motor driven roller 1408 may be different.

Similar to each pair of rollers 1002 in the first compression system 1000 (shown in FIG. 8), the pair of vertically aligned compression rollers 1402 is configured to apply a predetermined compressive force to join (e.g., bond, etc.) the fabric 1302 to the upper portion of the mesh 902 (not shown).

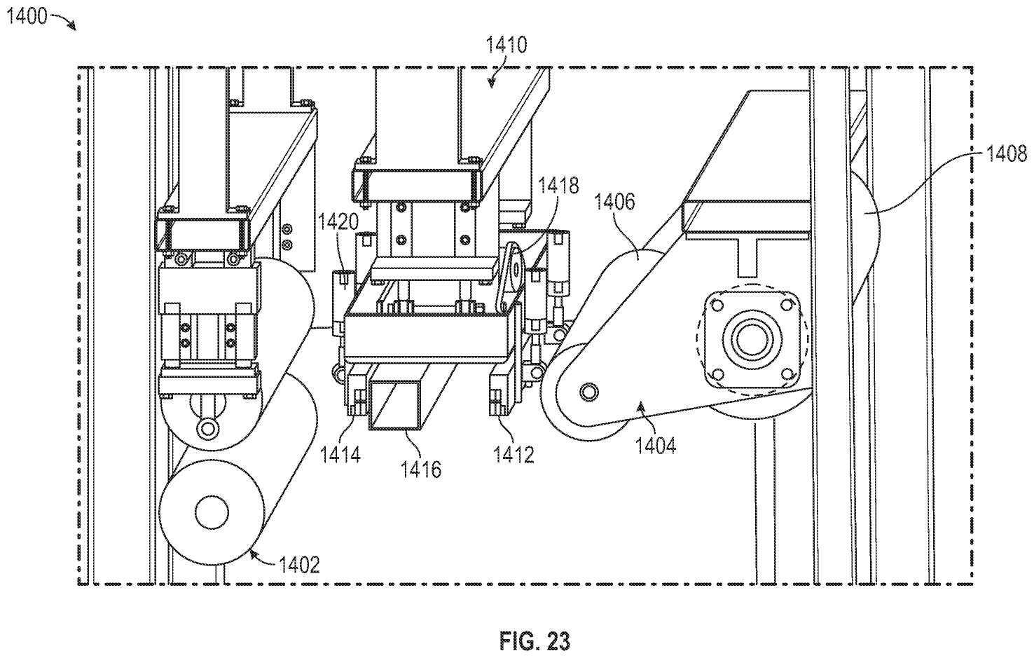

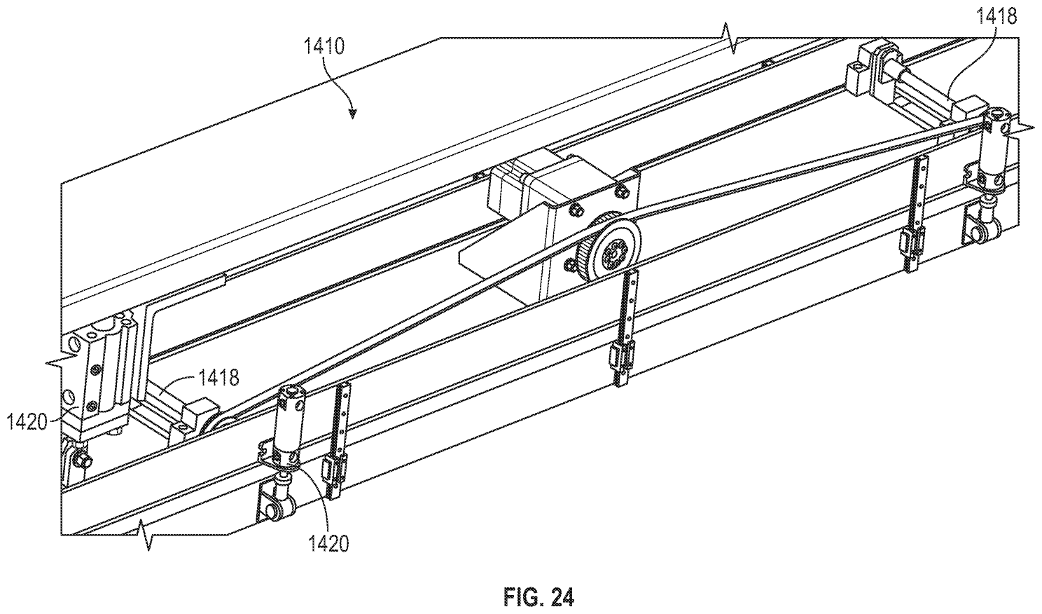

The bonding and cutting system 1400 of FIG. 22 additionally includes a clamping and cutting system, shown as clamp press 1410 that is configured to process a leading edge and a trailing edge of the cementitious composite after the final bonding operation. FIGS. 23-26 show the clamp press 1410, according to an exemplary embodiment. As shown in FIG. 23, the clamp press 1410 includes a leading edge cutting bar 1412, a trailing edge cutting bar 1414, and a press bar 1416. The press bar 1416 is disposed in a space between the cutting bars 1412, 1414. As shown in FIG. 24, the clamp press 1410 includes a pair of motor driven linear actuators 1418 configured to reposition the press bar 1416 relative to the cutting bars 1412, 1414. The clamp press 1410 additionally includes a plurality of actuators, shown as pneumatic actuators 1420, configured to independently lower and raise one of the leading edge cutting bar 1412, the trailing edge cutting bar 1414, and the entire clamp press 1410.

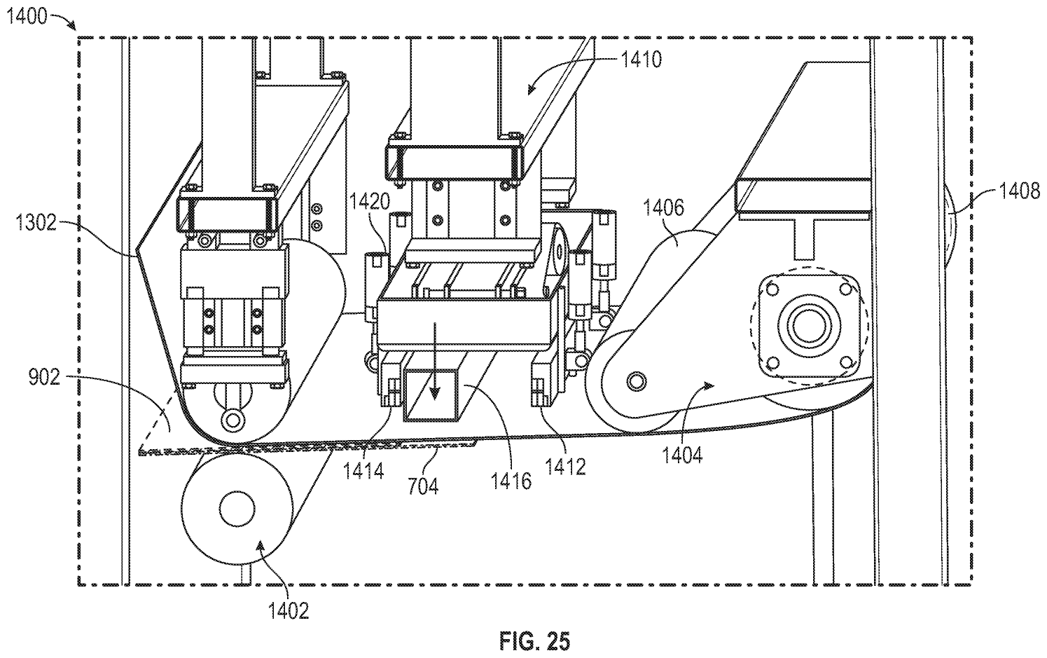

FIG. 25 depicts the clamp press 1410 positioned to join a leading edge of the cementitious composite such that the cement is fully encased within the mesh 902 between the fabric 1302 and the membrane 704. In the implementation shown, the membrane 704 extends beyond the mesh 902 by a distance that is slightly larger than a width of the press bar 1416 in the feed direction (e.g., 4 in. or another suitable distance depending on the structure of the cementitious composite). As shown in FIG. 25, the clamp press 1410 is configured to actuate the press bar 1416 to join the membrane 704 with the fabric 1302 proximate to the leading edge of the cementitious composite. Although not shown in FIG. 25, this joining operation may be performed with the press bar 1416 positioned proximate to the leading edge cutting bar 1412. The leading edge cutting bar 1412 is configured to actuate at approximately the same time as the press bar 1416 to cut the fabric 1302 and the membrane 704 along the leading edge. Any remaining fabric 1302 forward of the leading edge is wound into a roll form by the rotary feed system 1404.

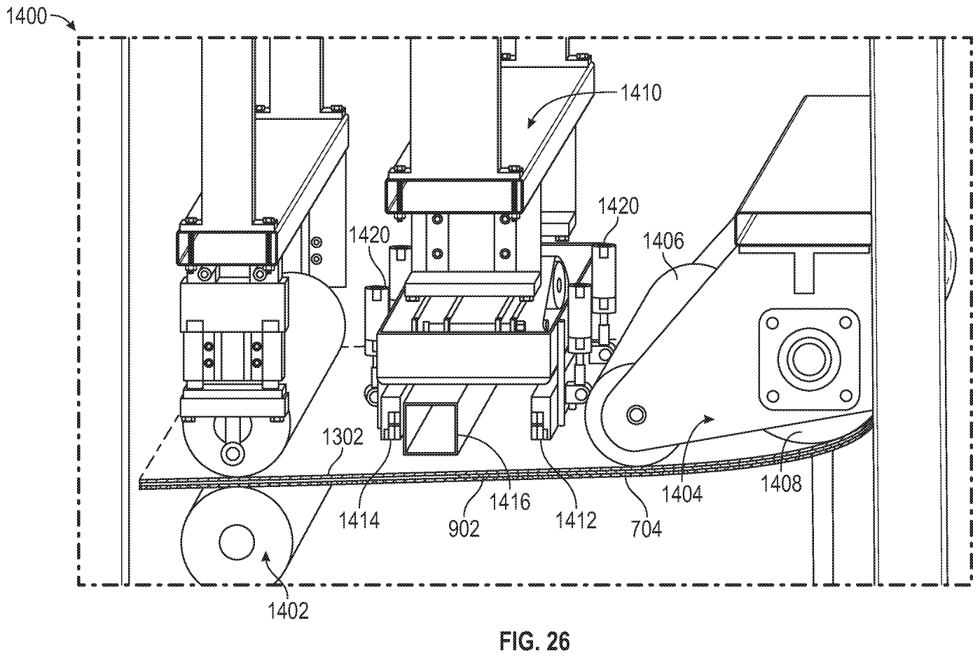

FIG. 26 depicts the clamp press 1410 positioned to join a trailing edge of the cementitious composite. As shown in FIG. 26, during the trailing edge joining operation the press bar 1416 is positioned proximate to the trailing edge cutting bar 1414. The clamp press 1410 is configured to actuate the press bar 1416 and the trailing edge cutting bar 1414 approximately simultaneously, depressing the fabric 1302 toward the membrane 704 and removing any additional material that extends beyond the trailing edge (e.g., fabric 1302 and membrane 704).

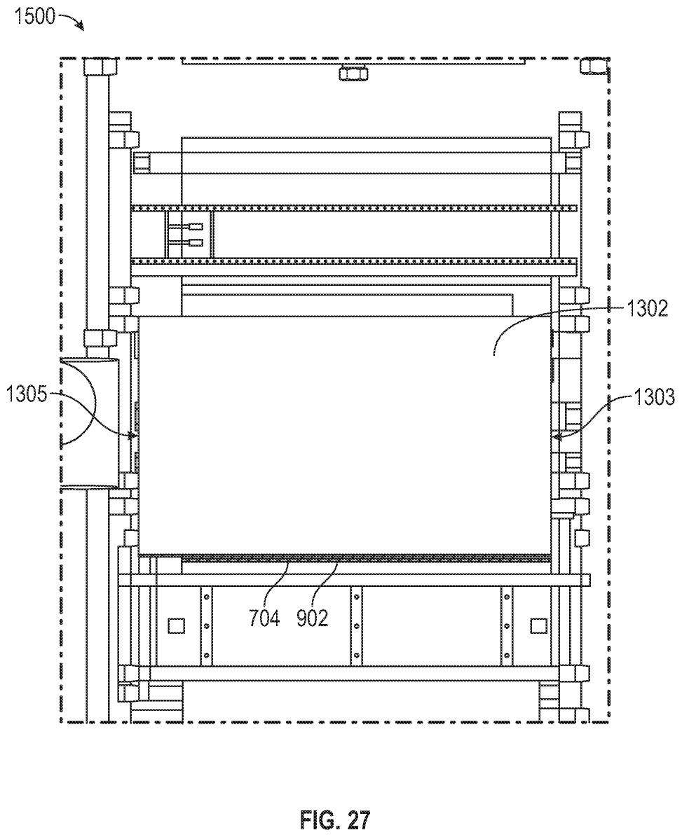

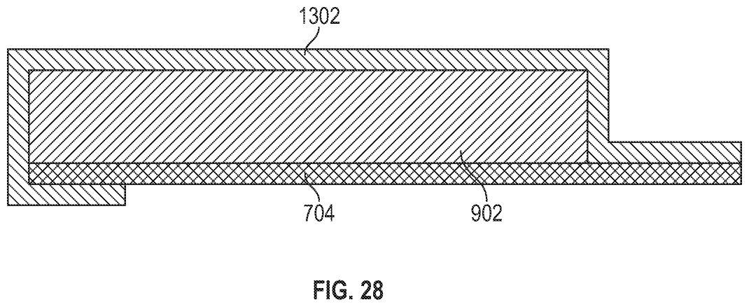

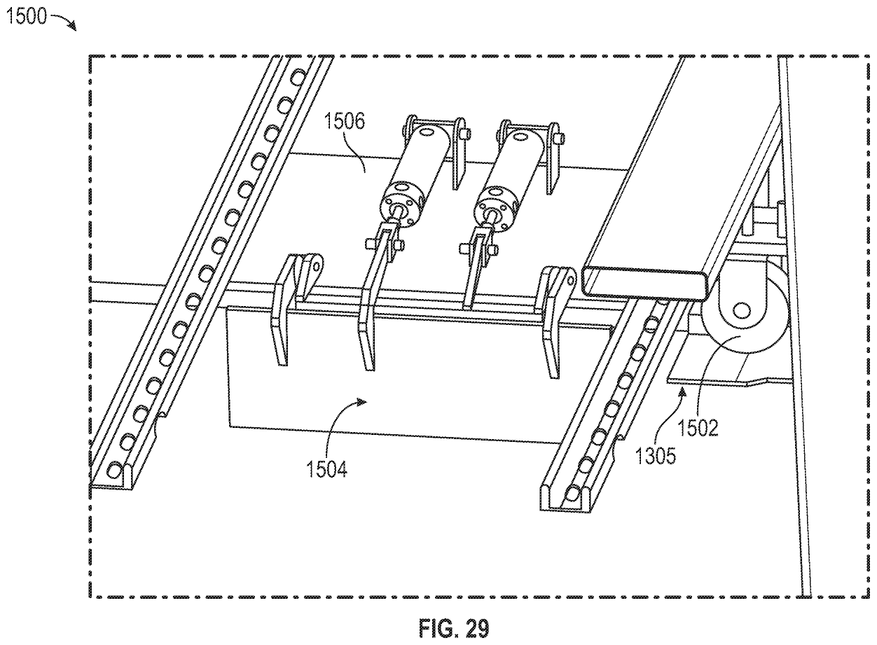

Similar to the leading edge and trailing edge processing operations described above, the manufacturing system 10 of FIGS. 2-3 is configured to join the fabric 1302 with the membrane 704 along each lateral edge of the cementitious composite (e.g., along the sides of the cementitious composite). FIGS. 27 and 29 show an exemplary embodiment of an edge forming system 1500 configured to manipulate the fabric 1302 along each lateral edge. FIG. 27 provides a top view of the cementitious composite as it is received by the edge forming system 1500. FIG. 28 shows a rear sectional view of the cementitious composite after the forming operation is complete. As shown in FIG. 27, both the fabric 1302 and the membrane 704 extend beyond a first lateral edge 1303 (e.g., a right side as shown in FIG. 27) of the cementitious composite, whereas on a second lateral edge 1305 of the cementitious composite, the fabric 1302 extends beyond both the mesh 902 and the membrane 704 and an edge of the mesh 902 is approximately flush with the membrane 704. In some implementations, a distance between a lateral edge of the mesh 902 and the fabric 1302 on either side of the cementitious composite is approximately 4 in.

The edge forming system 1500 includes a pair of pneumatically actuated edge rollers 1502 (see FIG. 29) configured to form the fabric 1302 downward toward the membrane 704 along either lateral edge of the cementitious composite. Along the first lateral edge, the edge roller 1502 is configured to compress the fabric 1302 toward the membrane 704. A similar forming/bending action is performed by the edge roller 1502 along the second lateral edge of the cementitious composite. A portion of the edge forming system 1500 proximate to the second lateral edge is shown in FIG. 29. In addition to the edge roller 1502, the edge forming system 1500 includes a tucking mechanism 1504 configured to fold the fabric 1302 around both the mesh 902 and the membrane 704. In the exemplary embodiment of FIG. 29, the tucking mechanism 1504 takes the form of a rectangular plate hingedly disposed on and coupled to an upper support 1506 of the edge forming system 1500 (e.g., an upper plate coupled to a support structure for the edge forming system). The tucking mechanism 1504 also includes a pair of actuators (e.g., pneumatic actuators, etc.) that, when activated, force the rectangular plate down and around the second lateral edge 1305 of the cementitious composite.

In the embodiment of FIGS. 2-3, the cementitious composite passes through another pair of vertically aligned compression rollers (not shown) configured to bond the fabric 1302 to a lower surface of the membrane 704 at any location where the tucking mechanism 1504 might not have adequately compressed the joint. The vertically aligned compression rollers also prevent any tension that is introduced by a winding system 600 for the cementitious composite from propagating to other subsystems forward of the vertically aligned compression rollers.

In some embodiments, the manufacturing system additionally includes a front-end attachment system configured to join the fabric with associated tooling mounted to a leading edge of the mesh and the membrane. In some embodiments, the front-end attachment system is configured to join a leading edge of the fabric, mesh, and membrane with a puller sheet used to guide the unfinished materials through the manufacturing system at the start of a production operation. According to an exemplary embodiment, the front-end attachment system is disposed after the compression rollers 1402 (see also FIG. 22). The front-end attachment system may include a rectangular bar that presses against the leading edge of the fabric and the puller sheet (e.g., that presses the fabric and the puller sheet down onto process tooling that is already connected to the leading edge of the mesh and membrane).

In some embodiments, the front-end attachment system is configured to cut excess lengths of fabric, mesh, or structural layer from the leading and/or trailing edge of the cementitious composite. The front-end attachment system may include a linear movement device that is configured to accommodate a cutting head or a tape-application head. The linear movement device may include a high-helix lead screw and a hand crank coupled to the high-helix screw. The hand crank may be used to move the cutting head and/or the tape-application head across the entire width of the cementitious composite. By way of example, the cutting head may be utilized to cut the back-end (e.g., a trailing edge) of the cementitious composite to provide a clean finished edge at the end of a production run. The tape-application head may be used to apply a band of adhesive tape in between the membrane and the fabric at the trailing and/or leading edge of the cementitious composite to ensure that the cement remains encased between the membrane and the fabric. In other embodiments, another manually operated clamp-type device may be used to clamp the membrane and the fabric together and to seal the membrane to the fabric at the leading and/or trailing edge.

In embodiments where a puller sheet is used to guide the cementitious composite through the various production stages, the manufacturing system may include a roll separating system to disconnect the puller sheet from the finished cementitious composite (at a leading edge of the cementitious composite). The roll separating system may be configured to position a leading edge of the cementitious composite against a core shaft of a final winder, which is used to wind the cementitious composite into a roll that is independent from the puller sheet. In various exemplary embodiments, the roll separating system includes a trap door device to facilitate engagement between the leading edge of the cementitious composite and the core shaft. The trap door device includes a pivotable plate, which may be manually rotated to lift or otherwise reposition the cementitious composite against the core shaft of the final winder. During a production run, the puller sheet slides horizontally in the feed direction across the plate. The plate may be actuated by rotating a lever disposed along a forward edge of the plate. The lever rotates about an axis that extends parallel to the forward edge of the plate, which draws the trailing edge of the plate upwards and toward the core shaft of the final winder.

The manufacturing system may include two winding devices (e.g., core shafts) at the end of the production line. A first core shaft may be used to draw the puller sheet through the manufacturing system into a bulk roll at the end of the production line. A second core shaft may form part of the final winder used to draw the cementitious composite into a bulk roll. The second core shaft may be positioned before the first core shaft in the feed direction along the production line. In some embodiments, the final winder may include load cells mounted within the safety chucks that are used to support the second core shaft. The load cells may be configured to provide a real-time measurement of the weight of the finished roll of cementitious composite, which in turn may be used by the HMI interface (not shown) or another control interface to determine a mix-fill density of the finished roll. For example, the load cell data may be used by the control system to compare the mix-fill density to a threshold mix-fill density, and thereby ensure that the finished roll meets specified targets.

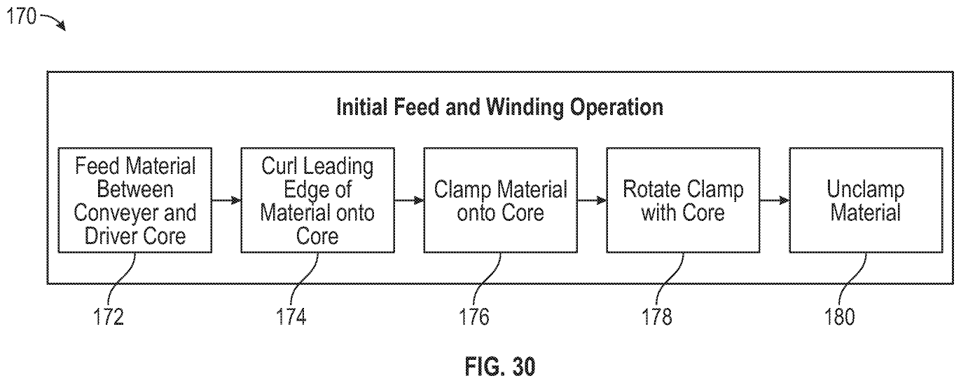

As shown in FIGS. 2-3, after leaving the edge forming system 1500, the completely formed cementitious composite is received by the winding system 600. As shown in FIG. 30, a method 170 of feeding and winding the cementitious composite, begins with feeding the cementitious composite between a conveyer 602 for the winding system 600 and a driven core 604, at 172.

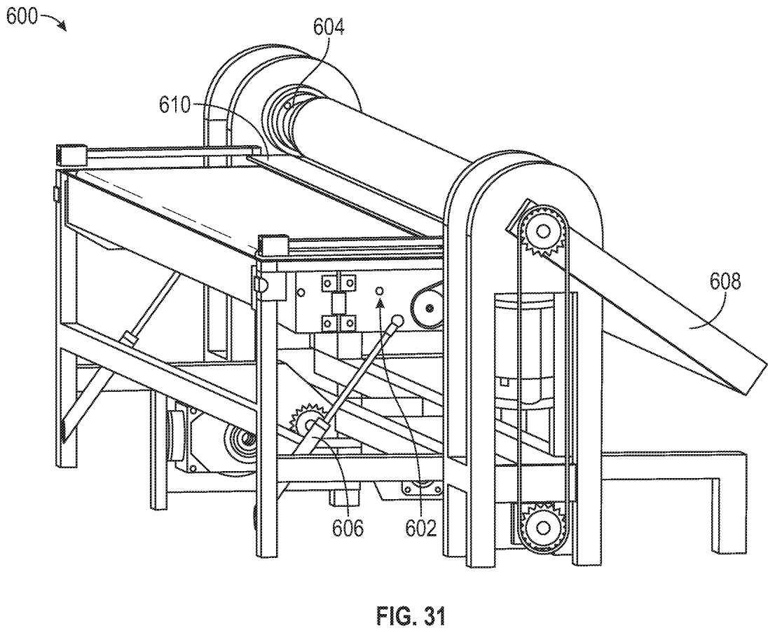

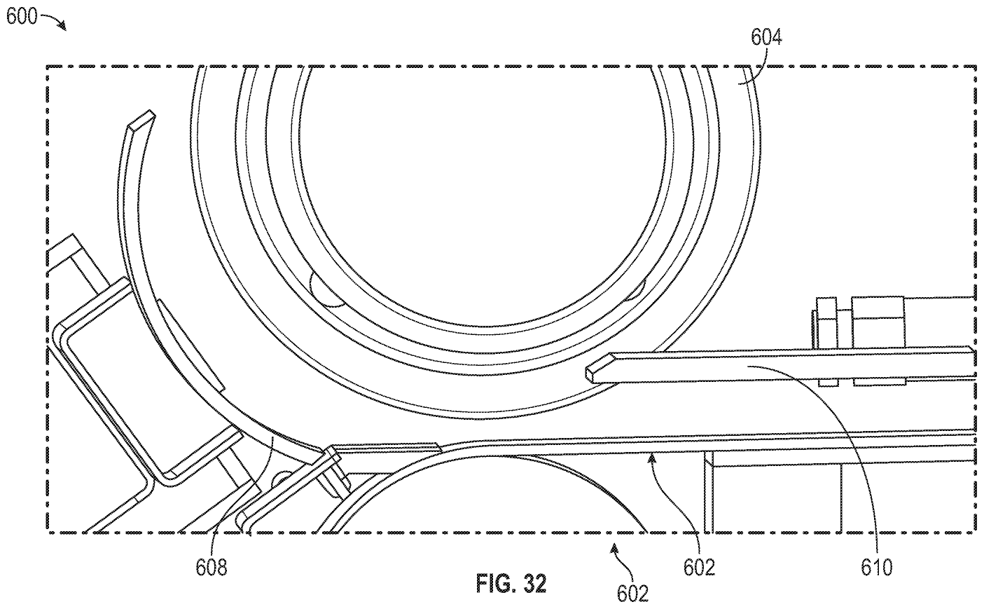

The conveyer 602 and the driven core 604 for the winding system 600 are shown in FIGS. 31-32, according to an exemplary embodiment. The conveyer 602 includes a pair of actuators, shown as actuators 606, configured to position the conveyer 602 relative to the driven core 604 (e.g., a core shaft similar to the shaft used to support the membrane unwinding system 700 of FIG. 4). The actuators 606 are configured to translate the conveyer 602 in a vertical direction toward and away from the driven core 604. In the embodiment of FIGS. 31-32, the actuators 606 take the form of pneumatic actuators configured to maintain a predetermined level of compression on a roll of cementitious composite throughout the winding operation. Block 172 may further include raising the conveyer 602 toward the driven core 604 to secure the cementitious composite in position with respect to the driven core 604.

The method 170 of FIG. 30 includes a leading edge curling operation, at 174, in which the leading edge of the cementitious material is wrapped about a first portion of the driven core 604 after initially feeding the cementitious composite between the conveyer 602 and the driven core 604.

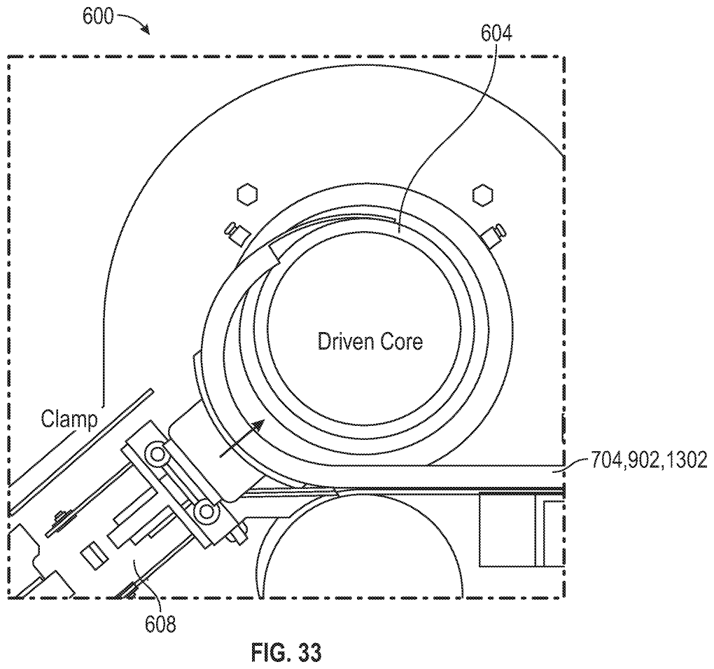

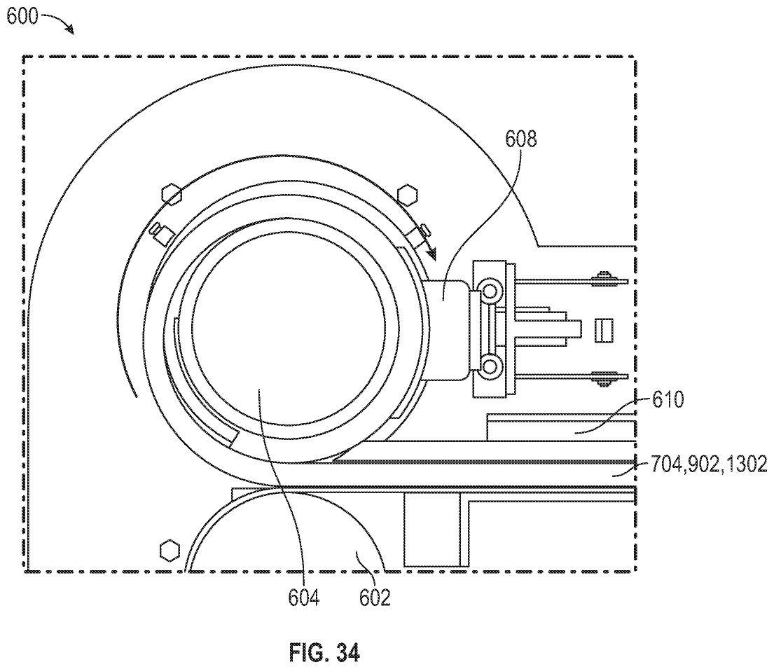

As shown in FIG. 32, the winding system 600 includes a clamp mechanism 608 and a pusher plate 610 that facilitate the initial feed operation. During the curling operation, the cementitious composite is inserted through a small passage in between the clamp mechanism 608 and the driven core 604. The clamp mechanism 608 redirects (e.g., curls) the leading edge of the cementitious composite upward and around a perimeter of the driven core 604 (see FIG. 33). As shown in FIG. 30, the initial feed and winding operation continues by clamping the cementitious material between the clamp mechanism 608 and the driven core 604, at 176 (e.g., using an actuator such as a pneumatic actuator that is coupled to the clamp mechanism 608). Block 176 may include activating an actuator, such as a pneumatic actuator that is coupled to the clamp mechanism 608 (see FIG. 33) to press the cementitious composite between the clamp mechanism 608 and the driven core 604. The method 170 (FIG. 30) continues by rotating the clamp mechanism 608 along with the driven core 604 around a perimeter of the driven core 604, at 178 (see FIG. 34). Block 178 may include activating a motor for the driven roller and/or clamp mechanism 608 to rotate the driven core 604. The motor may be controlled based on the measured tension applied to different input rolls (e.g., the membrane, the mesh, and/or the fabric). For example, the manufacturing system may utilize an open-loop torque control scheme in which an electronic drive (e.g., a variable frequency drive) for the motor controls the motor based on the measured tension. All of the rolls (e.g., the input rolls, and the bulk output roll of cementitious composite) may include motors that “follow” a master speed-controlled device such as one of the compression rollers (e.g., compression rollers 302 of FIGS. 2-3, etc.) or fabric joining roller (rollers 1402 of FIG. 22), and will effectively adjust their motion accordingly to maintain set torque parameters. In various exemplary embodiments, the speed at which the materials is fed through the manufacturing system may be approximately 10 ft/min. In other embodiments, and depending on the required geometry and properties of the cementitious composite, the feed speed may be different.

At 180 (FIG. 30), the clamp mechanism 608 is retracted away from the cementitious composite. Block 180 may additionally include redirecting the leading edge of the cementitious composite toward a lower portion of the driven core 604 and/or folding the leading edge of the cementitious composite beneath incoming material by using the pusher plate 610 as shown in FIG. 34. In the exemplary embodiment of FIGS. 31-34, the pusher plate 610 is configured to retract (e.g., via one or more pneumatic actuators) away from the roll as the amount of cementitious material deposited on the roll increases.

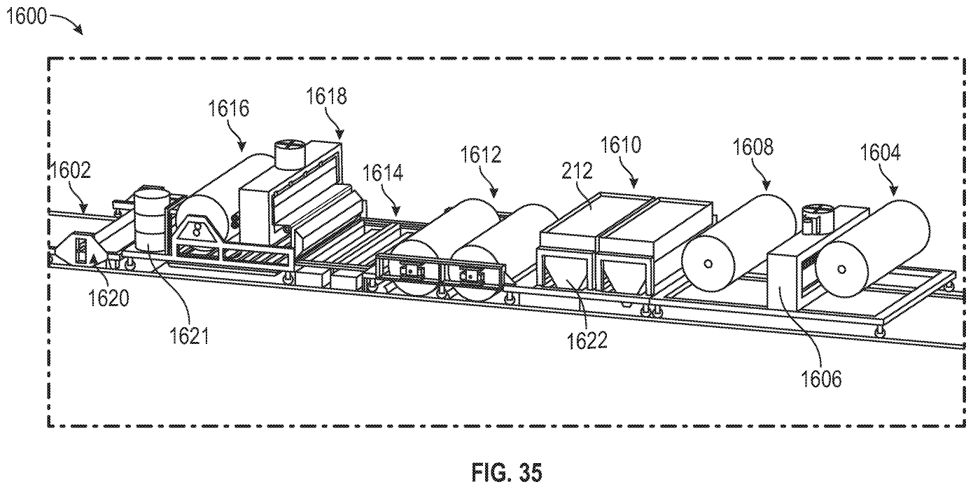

FIGS. 35-45 show various alternative embodiments of a manufacturing system for a cementitious composite. Each of the embodiments in FIGS. 35-45 include more or fewer processing operations depending on how the precursor materials for the cementitious materials (i.e., membrane layer, mesh layer, and fabric layer) are received and bonded. The number and arrangement of processing steps should not be considered limiting with respect to the general principles described herein.

In some embodiments, the cementitious composite is assembled manually or semi-manually on a floor space. In such an embodiment, the receiving material may be stationary (e.g., laid out on the floor) and the assembly equipment for the manufacturing system may move over the material. As used herein, the receiving material refers to a layer or sheet of material (e.g., mesh, membrane, fabric, etc.). In some exemplary embodiments, the receiving material is the mesh and the membrane, which may be attached using an adhesive operation, a heating operation, ultrasonically, etc. Alternatively, the receiving material is a pre-bonded strip of the membrane and the mesh laid out along the floor space. A cement dispensing system (e.g., assembly equipment for the manufacturing system) may be manually moved by laborers over the mesh to deposit cement onto the mesh. In some exemplary embodiments, the cement dispensing system is a wheeled basin with a screed or a mechanical valve to meter the flow rate of cement onto the mesh and to provide cement in approximately uniform thickness across the mesh. The cement dispensing system may additionally include a compressed air system to improve the flow of material (e.g., cement) from the basin to the mesh. For example, the compressed air system may be configured to perturb the cement within the basin in order to prevent the cement from sticking to the walls of the basin or otherwise clogging within the basin.

In some exemplary embodiments, the cement may be distributed and compressed by laborers using a compression roller or mechanical compaction bar/plate that is pushed or moved along the material manually. The cement dispensing system may pass over the mesh for a second time after compaction, followed again by a manual distribution and compaction operation. The process may be repeated as many times as needed to fully impregnate the mesh with cement. In some embodiments, the laborers may use a shovel or other manual cement distribution device to apply the cement to the mesh. A brush may be manually applied over the top of the mesh fibers after compaction. One of an adhesive application system or a heating system may be used to attach the top fabric to the top of the mesh fibers. The adhesive application system or heating system may be disposed on wheels and may be manually drawn by the laborers over the mesh before the fabric is applied. Alternatively, the adhesive application system or heating system may be configured as handheld units (e.g., the adhesive application system may be configured as a hand spray gun, the heating system may be configured as a heated plate or iron, etc.). The adhesive application system may be used to apply adhesive as an alternative to, or in combination with heating. The adhesive application system may be configured to spray adhesive onto a bottom, mesh facing surface of the fabric, or on the mesh fibers directly. The adhesive application system may be a spray unit or an extrusion unit, which may be manually drawn with or without wheels over the mesh or along with a fabric application system. The heating system may be configured to heat and melt the mesh to the top fabric over the fabric, after the fabric is applied and in contact with the mesh. The fabric may be attached to a fabric application system (e.g., handled or mechanically suspended), or supported/held in a wheeled suspension/application system. The finished roll of cementitious composite may be manually wound onto a core (e.g., by laborer rotating the cementitious composite around a core or shaft).

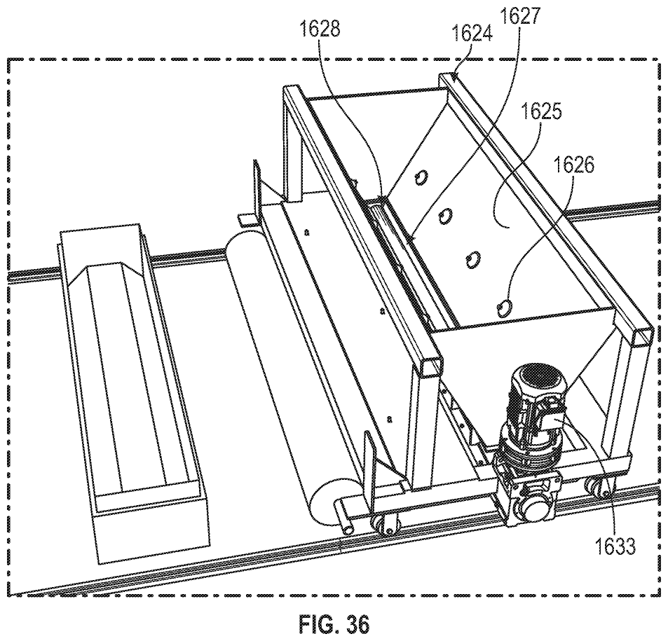

A manufacturing system 1600 for a cementitious composite including a tracked conveyer system is shown in FIG. 35, according to an exemplary embodiment. The manufacturing system 1600 includes a plurality of modules (i.e., subsystems), each movably disposed on a pair of tracks 1602 for the manufacturing system 1600. Each module includes a set of rollers that interface with the tracks. Each of the modules is configured to move along the tracks independently or in concert depending on processing requirements. In other implementations, floor guides may be used instead of tracks 1602. Each module may be coupled to the floor guides on one or both sides of the module using wheels to maintain the module (e.g., machining unit) in position. For example, the wheels may engage with the floor guides to prevent a given module from moving a direction that is normal to the feed direction. A region between tracks 1602 provides a surface (e.g., a floor space) upon which materials (e.g., receiving materials) for the cementitious composite may be distributed. In operation, each module moves in a direction (e.g., opposite the membrane feed direction, left to right as shown in FIG. 35) along the tracks. As shown in FIG. 35, the manufacturing system 1600 includes a membrane unwinding system 1604, a first adhesive application system 1606 (including an adhesive barrel or holding unit 1621), a mesh unwinding system 1608, a cement dispensing system 1610 (e.g., multiple hoppers with screed, see also FIG. 36), a compression and cement distribution system 1612, a heating system 1614 (e.g., a radiant heating system, etc.), a fabric unwinding system 1616, a second adhesive application system 1618, and a winding system 1620. The function of each system is substantially similar to the corresponding systems described in FIGS. 2-3. However, unlike the manufacturing system 10 of FIGS. 2-3, any compression rollers used in the manufacturing system 1600 of FIG. 35 are configured to act against a stationary surface upon which the track is disposed (e.g., a cement ground surface, floor space, etc.), thereby eliminating the need for pairs of vertically aligned rollers (e.g., pairs of diametrically opposed rollers that press together to squeeze or compress the receiving materials).

The processing speeds and feed rates for each module may be varied independently by varying a speed at which each module is moved along the track. As shown in FIG. 35, the cement dispensing system 1610 includes a pair of distribution hoppers 1622. Cement 212 is manually fed into each distribution hopper 1622, into an interior cavity formed by each distribution hopper 1622, and distributed onto the mesh though a rectangular slot (not shown) at the base (e.g., a lower portion, lower wall, etc.) of each hopper 1622. In one embodiment, a valve (e.g., a rotary valve) may be used to control the flow rate of cement through the slot (referred to herein as a rotary valve depositing system). In yet other embodiments, a spreader bar may be used to distribute a layer of cement onto a mesh layer. The spreader bar may be a bar disposed along the base of each hopper 1622 and extending along a width of the hopper 1622 in substantially perpendicular orientation relative to the feed direction. A height of the spreader bar may be sized to set a thickness of the cement above the mesh layer. The spreader bar may be coupled to an actuator to rotate the spreader bar or draw the spreader bar across the mesh periodically (e.g., draw diagonally across, etc.). In yet other embodiments, a hopper may be outfitted with a mechanical shaker system or vibratory system to mechanically oscillate the hopper and thereby facilitate removal of the cement from the hopper (e.g., through the slot at the base of the hopper).

The cement depositing methods described herein should not be considered limiting. Many alternatives are possible without departing from the inventive concepts disclosed herein. For example, in some embodiments, the hopper 1622 may be replaced with a bias cut conveyer (e.g., the slotted housing 232 of the cement dispensing system 200 shown in FIGS. 2-3). In yet other embodiments, cement dispensing system 1610 includes a batched dumping system in which a predefined amount of cement is periodically dropped onto the mesh. The batched dumping system may include a hopper and a mechanical spreader. The cement dispensing system 1610 may be configured to dispense a predefined amount (e.g., pile) of cement onto the mesh and the spread the cement approximately evenly across the mess as the mesh is fed through the cement dispensing system 1610. In other embodiments, the batched dumping system may include allocating a predefined amount of cement into a secondary hopper and dispensing the cement at from the secondary hopper at a single point in time (e.g., as a single batch rather than continuously flowing cement onto the mesh. In yet other embodiments, the cement dispensing system 1610 includes a screw feeder that is configured to dispense cement continuously onto the mesh. The screw feeder may include an outer housing and a central auger, similar to the feeder 230 of FIG. 11. The flow rate of cement from the screw feeder may be set based on the rotational speed of the central auger. In yet other embodiments, a screed (e.g., a separate cement leveling system) may be used to distribute a layer of cement onto a mesh layer. In embodiments using a valve or screed to control the flow and distribution of cement onto the mesh (i.e., non-bias cut dispensing units), the application of cement may be facilitated using nozzles spaced on the depositing unit basin (e.g., a distribution hopper) to improve the flow of cement from the basin. The nozzles may be driven using compressed air.

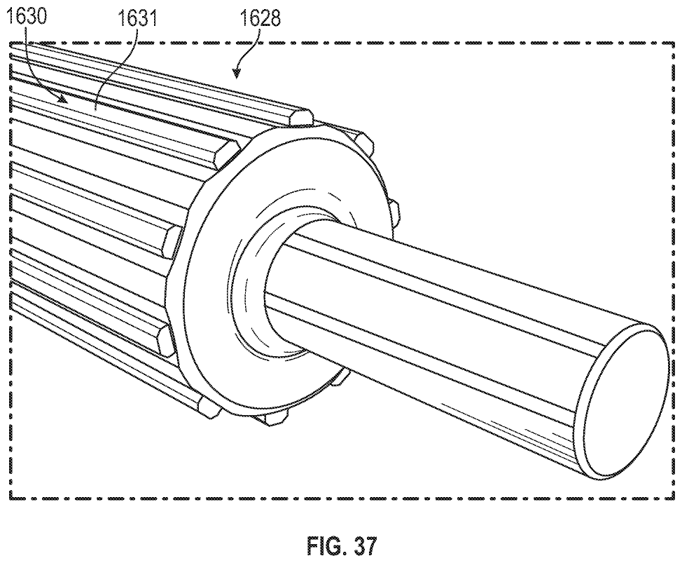

An exemplary embodiment of a distribution hopper 1624 including nozzles 1626 is shown in FIG. 36. The nozzles 1626 are disposed along a length of each of two opposing side walls 1625 (e.g., sidewalls angled downwardly toward a rectangular slot 1627 at the base of the distribution hopper 1624) of the distribution hopper 1624. The nozzles 1626 are configured to provide a flow of compressed air to agitate the contents of the distribution hopper 1624 (e.g., the cement) for more uniform flow distribution through the slot 1627. The distribution hopper 1624 additionally includes a screed 1628 to facilitate dispensing of the cement through the slot 1627 in the lower part of the distribution hopper 1624. The screed 1628 is disposed in fluid receiving communication with the slot 1627 (e.g., beneath the slot 1627 so as to receive cementitious material from the hopper 1624) and is centered with respect to the slot 1627. FIG. 37 shows the screed 1628 isolated from the distribution hopper 1624. The screed 1628 includes a cylindrical shaft and a plurality of ridges 1630 coupled to the shaft. Each of the plurality of ridges 1630 extends in a longitudinal direction along an outer surface of the cylindrical shaft, in a substantially parallel orientation relative to a central axis of the cylindrical shaft. The ridges 1630 are configured to allocate and distribute the cement upon rotation of the screed 1628. By way of example, as the screed 1628 rotates, cement material is deposited between the ridges 1630. Rotation of the screed 1628 draws the cement out of the hopper 1624 (see also FIG. 36) and drops the cement from between the ridges 1630 onto the receiving material. The ridges 1630, which have a substantially planar outer surface 1631 spaced apart from the central shaft, rotate across the receiving material as is passes beneath the screed 1628, thereby distributing the deposited cement approximately evenly across the receiving material. Rotational speed of the screed 1628 is controlled using a motor 1633 coupled to the screed 1628 as shown in FIG. 36.

In other embodiments, the cement dispensing system 1610 may include other conveyor-based dispensing equipment (e.g., a separate conveyor that discharges cement above the mesh, etc.). The cement may also be pumped or fed pneumatically, hydraulically, or by any other dispensing means now known or hereafter devised.

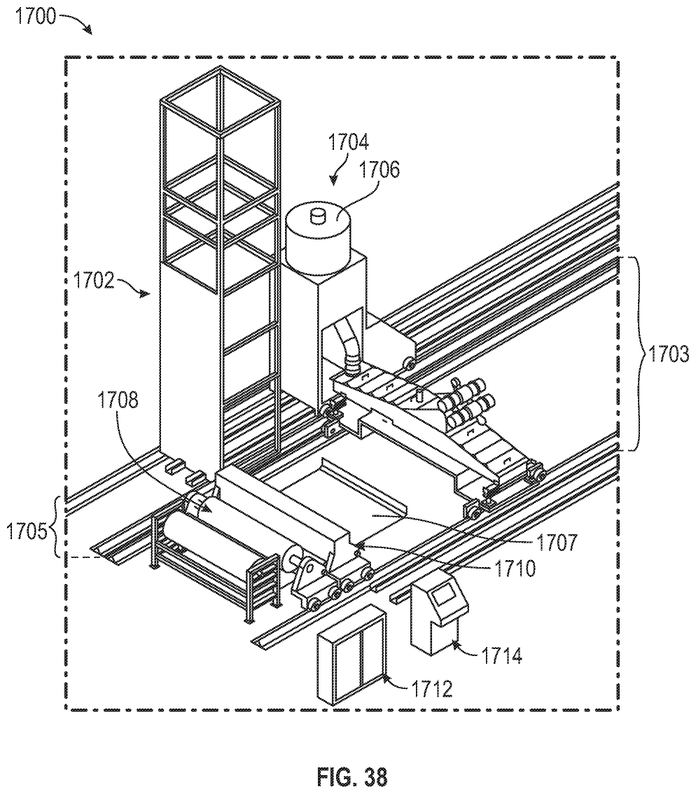

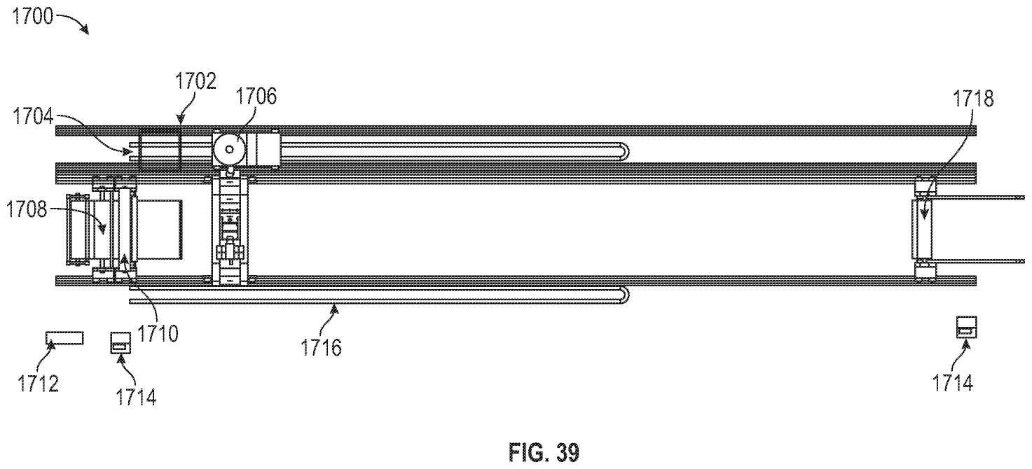

An exemplary embodiment of a manufacturing system, shown as manufacturing system 1700, for a cementitious composite including a tracked cement dispensing system 1702 is shown in FIGS. 38-40. As shown in FIG. 38, the cement dispensing system 1702 is coupled to at least two pairs of tracks. A bias cut conveyer system 1701 (e.g., the slotted housing 232 of the cement dispensing system 200 shown in FIGS. 2-3) is coupled to a first pair of tracks 1703, while an unbagging system 1704 and a hopper 1706 are each coupled to a second pair of tracks 1705. In alternative embodiments, a screed, rotary valve depositing system, or another suitable cement feeding/dispensing mechanism takes the place of the bias cut conveyer system 1701. As shown in FIG. 38, the manufacturing system 1700 uses a pre-bonded roll 1707 of membrane and mesh that is fixed in position at a first end of the first pair of tracks 1703. Using a pre-bonded roll 1707 of membrane and mesh eliminates the need for an adhesive application system. In operation, as shown in FIGS. 38 and 39, the materials (e.g., membrane, mesh, and fabric) are unwound and fed along the space in between the first pair of tracks 1703. The manufacturing system 1700 of FIGS. 38-40 includes a fabric unwinding system 1708 and a heating system 1710 (e.g., a radiant heating system, etc.) that are coupled to the first pair of tracks 1703 via a set of rollers that allow each of the unwinding system 1708 and the heating system 1710 to move along the first pair of tracks 1703. As shown in FIG. 39, the manufacturing system 1700 includes a cable track 1716 configured to facilitate movement of each module along the first and/or second pairs of tracks. The manufacturing system 1700 additionally includes a controls enclosure 1712, a human-to-machine control interface system 1714, and a winding system 1718 for the cementitious composite, which is located at a far end of the first pair of tracks 1703.

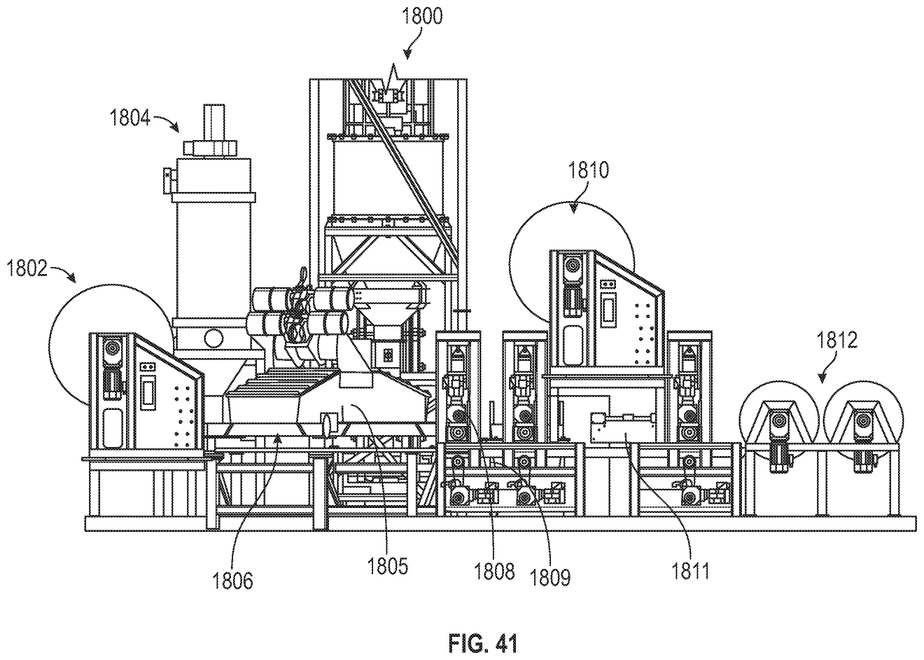

FIG. 41 shows another embodiment of a manufacturing system for a cementitious composite, shown as manufacturing system 1800. Like the manufacturing system 1700 of FIGS. 38-40, the manufacturing system 1800 of FIG. 41 uses pre-bonded membrane and mesh layers as well as a pretreated fabric layer to reduce the number of processing operations. The manufacturing system 1800 includes a combined membrane and mesh unwinding system 1802, a cement dispensing system 1804 including an automatic cement feed system 1806, a compression and cement distribution system 1808 (including brushes 1809), a fabric unwinding system 1810, a heating system 1811 (e.g., a heating system configured to melt and/or soften an upper surface of the mesh), and a winding system 1812 for the finished cementitious composite. Using a pre-bonded membrane and mesh layer as well as a pre-treated fabric layer eliminates the need for an adhesive application system and/or heat treatment system (e.g., a radiant heating system, etc.). As with other embodiments described herein, the cement dispensing system 1804 may take the form of a bias cut conveyer, a screed, a rotary valve depositing system, or another suitable cement feeding/dispensing mechanism. In the embodiment of FIG. 41, the cement dispensing system 1804 includes a bias cut conveyer 1805.

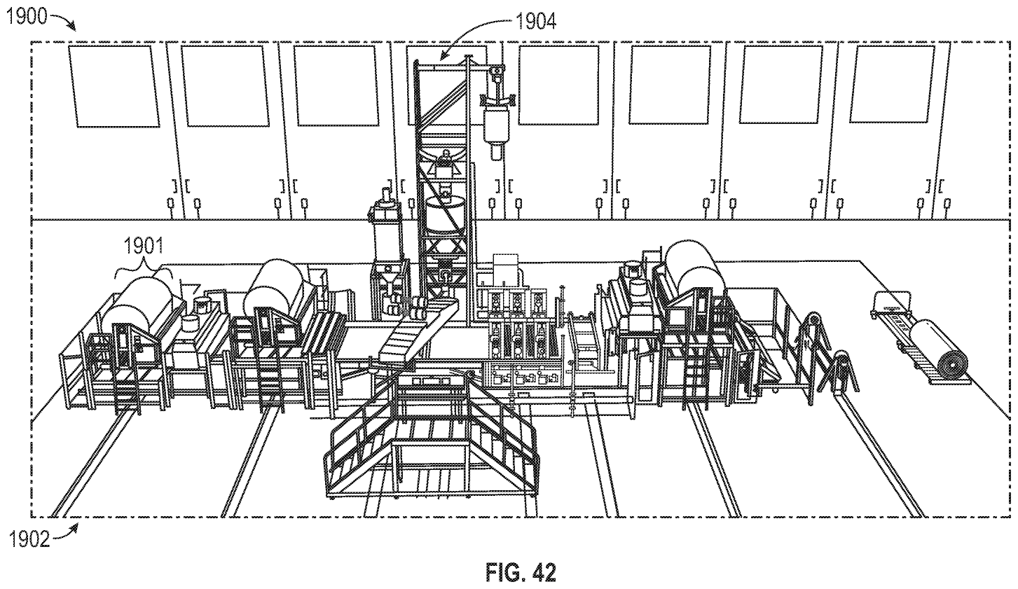

FIG. 42 shows another embodiment of a manufacturing system for a cementitious composite, shown as manufacturing system 1900. The manufacturing system 1900 shown in FIG. 42 is the same as the manufacturing system 10 of FIGS. 2-3. However, each module 1901 of the manufacturing system 1900 of FIG. 42 is moveably coupled to a track system 1902, which is configured to allow for quick and easy placement and alignment of the various processing modules 1901. Specifically, each module 1901 may be repositioned relative to one another laterally, in a direction that is substantially perpendicular to the feed direction. Although not shown, a secondary track is included that interfaces with a portion of a cement dispensing system 1904. The secondary track is configured to facilitate placement and alignment of the cement dispensing system 1904 relative to other components in the manufacturing system 1900. Again, the cement dispensing system may be one of a bias cut conveyer (as shown in FIG. 42), a screed, a rotary valve depositing system, or another suitable cement feeding/dispensing mechanism.

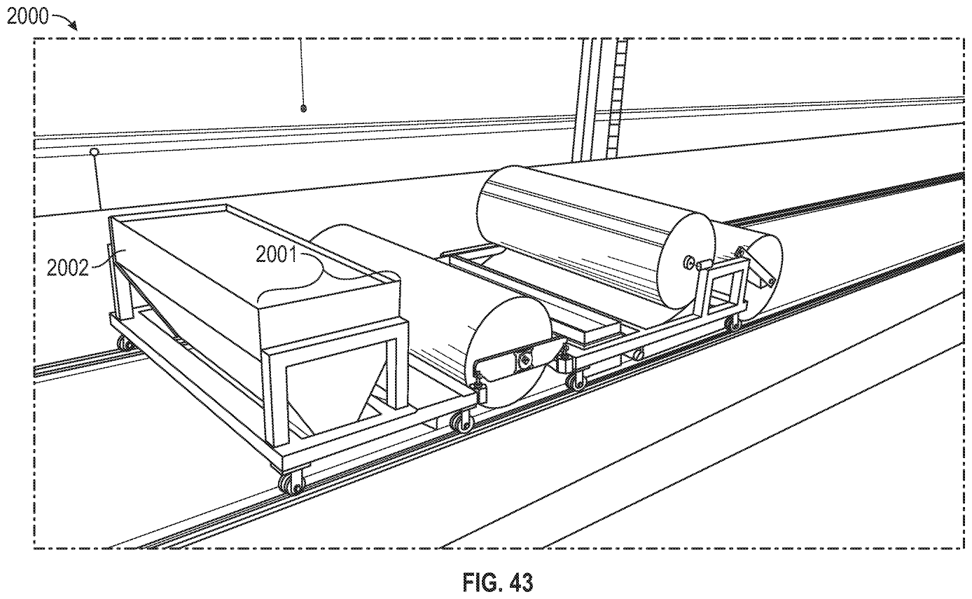

FIG. 43 shows yet another embodiment of a manufacturing system for a cementitious composite, shown as manufacturing system 2000. Like the exemplary embodiments of FIGS. 35-40, the manufacturing system 2000 includes modules 2001 that are configured to move along a pair of tracks (e.g., from right to left as shown in FIG. 43) relative to a stationary receiving material (e.g., the receiving material is placed on a stationary floor surface for treatment beneath the moving modules 2001). The manufacturing system 2000 of FIG. 43 includes a single cement distribution hopper 2002, although multiple distribution hoppers may be used in other embodiments. In the exemplary embodiment of FIG. 43, a capacity of the cement distribution hopper 2002 may be approximately equivalent to the capacity required for a single batch of cementitious composite. In yet other embodiments, the distribution hopper 2002 is replaced with a bias cut conveyer or a screed. In other embodiments, the distribution hopper 2002 may be configured to receive cement 212 from one of a bulk silo, an unbagging system, manually from super sacks of cement, or another cement loading system. Again, the manufacturing system 2000 may or may not include an adhesive treatment system depending on the materials provided (e.g., pre-bonded membrane and mesh, etc.).

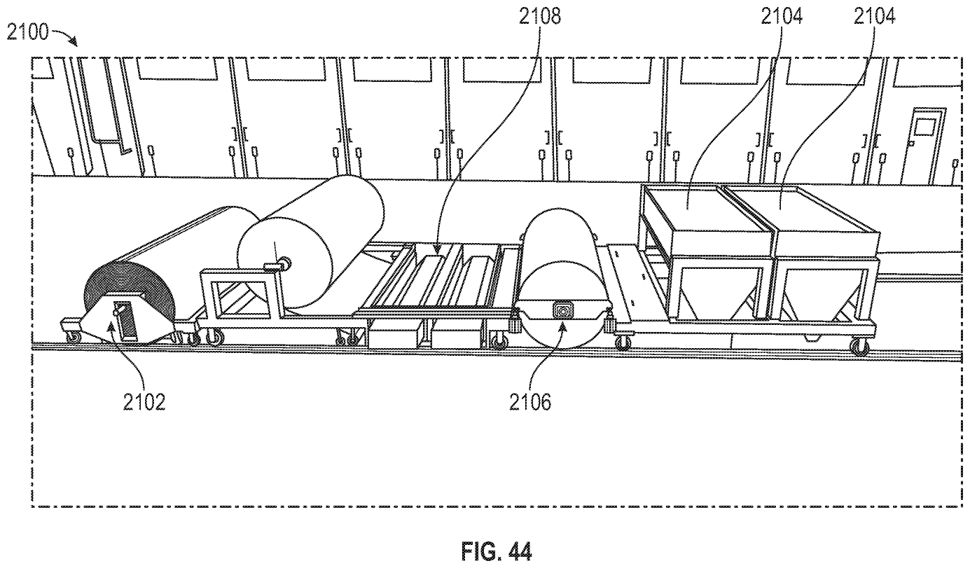

FIG. 44 shows another embodiment of a manufacturing system for a cementitious composite, shown as manufacturing system 2100. The manufacturing system 2100 includes a floor unloading system 2102 (e.g., a winding system), a rotary valve controlled cement distribution hopper 2104 that includes a screed (not shown—see also FIG. 36), a compression and cement distribution system 2106, a heating system 2108, and a fabric unwinding system 2110. Again, a bias cut conveyer or screed may be used in place of the distribution hopper. In operation, the manufacturing system 2100 is configured to move along the pair of tracks (e.g., from left to right as shown in FIG. 44) and across a layer of stationary receiving material (e.g., membrane).

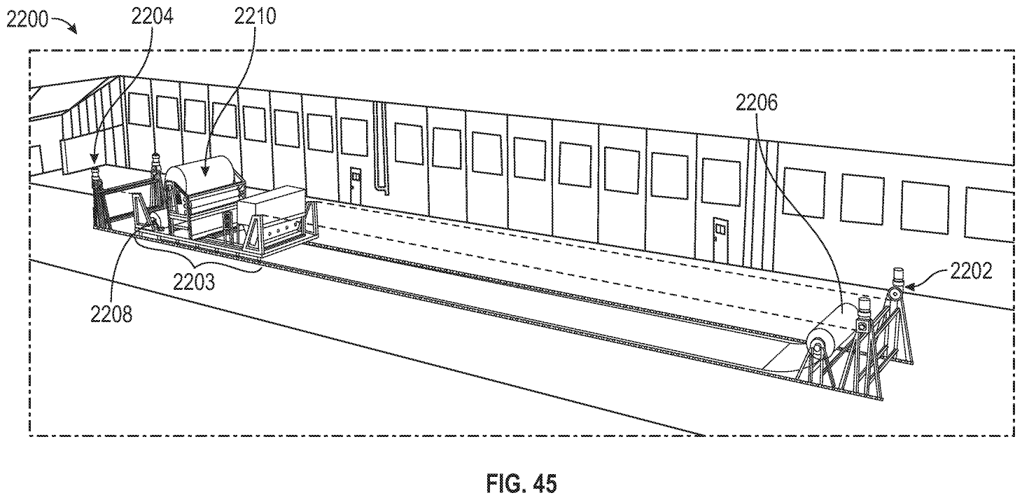

Yet another exemplary embodiment of a manufacturing system for a cementitious composite, shown as manufacturing system 2200, is shown in FIG. 45. The manufacturing system 2200 includes winches 2202 and 2204 configured move a cart 2203 containing modules and associated cement depositing equipment along a track system. As shown in FIG. 45, the winches 2202, 2204 are located at opposite ends of a pair of tracks. The winches 2202, 2204 are configured to work in concert to control the movement (e.g., feed and material processing rates, position, etc.) of the cart 2203. A similar winch configuration may be applied to any tracked equipment configuration as an alternative to motors on the cart 2203 or on each module. In some embodiments, winch 2204 is further configured to facilitate loading of a fabric roll 2210.

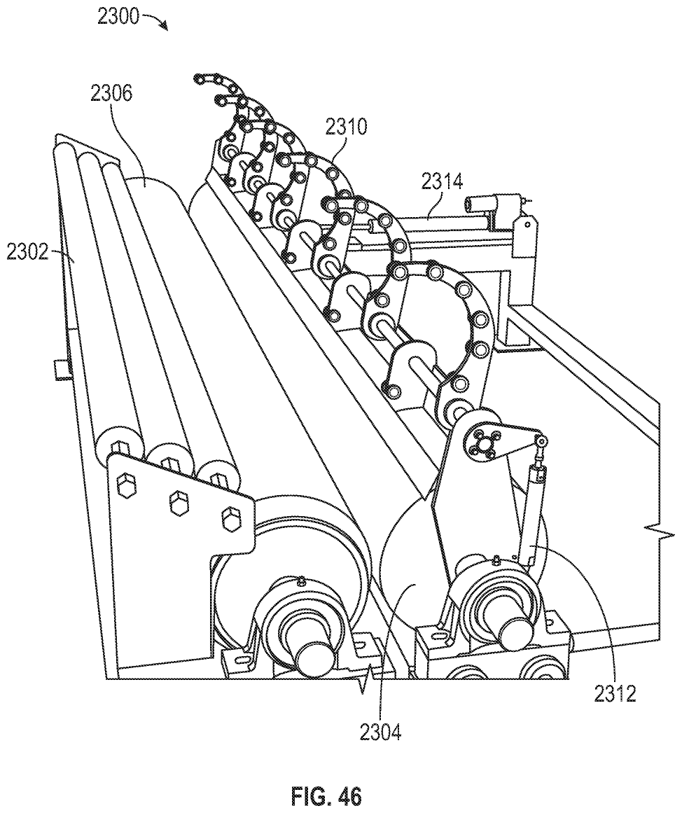

Similar to the cement depositing system, a variety of different winding systems for the cementitious composite are contemplated. An exemplary embodiment of a winding system 2300 is shown in FIG. 46, according to an exemplary embodiment. The winding system 2300 includes a plurality of guide rollers 2302, a driven roller 2304, and an idler roller 2306. As shown in FIG. 46, the winding system 2300 includes three guide rollers 2302 aligned with one another. The guide rollers 2302 are configured to guide the cementitious composite toward the driven roller 2304 (e.g., along a feed direction for the cementitious composite, at least partially downward relative to the feed direction, etc.). The driven roller 2304 and the idler roller 2306 are aligned horizontally (e.g., right to left in FIG. 46, in a feed direction for the cementitious composite, etc.). The winding system 2300 further includes at least two actuators and a plurality of guide members 2310. A guide member actuator 2312 is configured to manipulate each one of the plurality of guide members 2310. A roller actuator 2314 is configured to reposition the idler roller 2306 relative to the driven roller 2304 (e.g., toward or away from the driven roller 2304 in the feed direction).

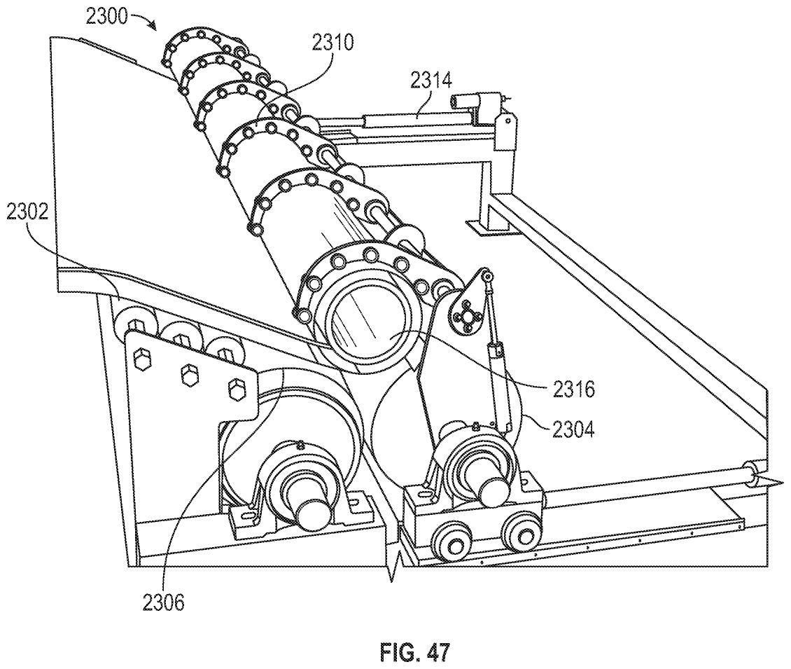

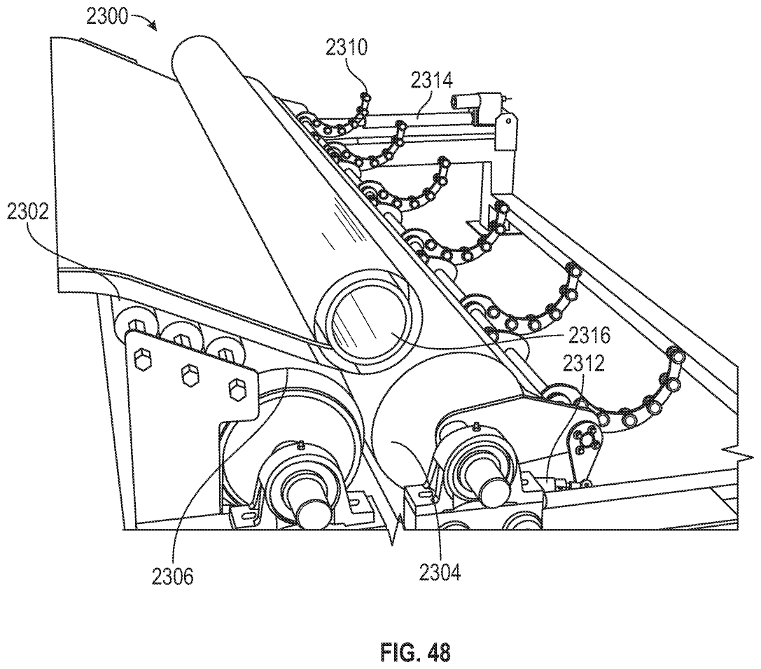

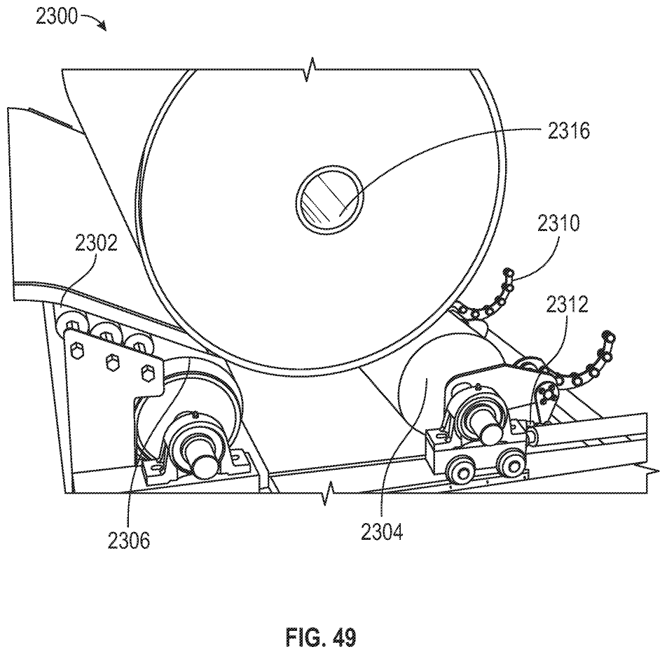

FIGS. 47-49 illustrate a winding operation for the winding system 2300, according to an exemplary embodiment. As shown in FIG. 47, a forming roller 2316 is configured to be received by the winding system 2300 between the driven roller 2304 and the idler roller 2306. A method of winding includes repositioning the plurality of guide members 2310 over the forming roller 2316. As shown in FIG. 47, the guide member actuator 2312 rotates the guide members 2310 (e.g., fingers, each finger including a plurality of roller wheels disposed thereon) into position over the forming roller 2316. The method includes feeding the cementitious composite through a gap between the forming roller 2316 and the combination of the driven roller 2304 and idler roller 2306. The cementitious composite is directed by the guide members 2310 through a gap in between the guide members 2310 and the forming roller 2316. As shown in FIG. 48, the method further includes retracting the guide members 2310 using the guide member actuator 2312 and continuing the wind operation via the driven roller 2304. As shown in FIG. 49, the method further includes moving the idler roller 2306 relative to the driven roller 2304 using the roller actuator 2314 (e.g., one or more pneumatic actuators disposed proximate to an end of the idler roller 2306 and configured to reposition the idler roller 2306 along tracks on either side of the idler roller 2306). The roller actuator 2314 slowly moves the idler roller 2306 as a diameter of the winding increases. A forklift or other winding removal mechanism may be used to reposition the finished roll of cementitious composite after winding, at which point the idler roller 2306 may be automatically repositioned proximate to the driven roller 2304.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It should be noted that the orientation of various elements may differ according to other exemplary embodiments and that such variations are intended to be encompassed by the present disclosure.

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the enclosure may be constructed from any of a wide variety of materials that provide sufficient strength or durability, in any of a wide variety of colors, textures, and combinations. Additionally, in the subject description, the word “exemplary” may be used to mean serving as an example, instance or illustration. Any embodiment or design described herein as “exemplary” may be not necessarily to be construed as preferred or advantageous over other embodiments or designs. Rather, use of the word exemplary may be intended to present concepts in a concrete manner. Accordingly, all such modifications are intended to be included within the scope of the present inventions. The order or sequence of any process or method steps may be varied or re-sequenced according to alternative embodiments. Any means-plus-function clause may be intended to cover the structures described herein as performing the recited function and not only structural equivalents but also equivalent structures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A system for making a cementitious composite, the system comprising:
a cementitious material supply system for dispensing a powdered cementitious material or a semi-powdered cementitious material into a receiving material, the receiving material comprising:
a structural layer comprising an open continuous volume extending from a first side to a second side opposite the first side; and
a sealing layer coupled to the first side, the cementitious material supply system configured to dispense the powdered cementitious material or the semi-powdered cementitious material into the open continuous volume to fill the open continuous volume.

2. The system of claim 1, wherein the cementitious material supply system dispenses the powdered cementitious material or the semi-powdered cementitious material from the second side of the structural layer such that the structural layer is filled from the first side to the second side.

3. The system of claim 1, wherein the cementitious material supply system is configured to continuously spread the powdered cementitious material or the semi-powdered cementitious material over the receiving material.

4. The system of claim 1, wherein the cementitious material supply system is configured to dispense the powdered cementitious material or a semi-powdered cementitious material non-continuously into the receiving material in multiple discrete stages.

5. The system of claim 1, wherein the cementitious material supply system comprises at least one of:
a hopper and a screed coupled to the hopper;
a hopper and a compressed air system coupled to the hopper;
a bias cut conveyer assembly;
a hopper and a rotary valve coupled to the hopper;
a rotary valve;
a hopper and a mechanical shaker system coupled to the hopper; or
a batched dumping system.

6. The system of claim 1, wherein the cementitious material supply system is stationary, and wherein the receiving material is moving.

7. The system of claim 1, wherein the cementitious material supply system is moving, and wherein the receiving material is stationary.

8. The system of claim 7, further comprising a plurality of tracks, wherein the cementitious material supply system is coupled to the plurality of tracks.

9. The system of claim 8, further comprising a first winch disposed at a first end of the plurality of tracks, and a second winch disposed at a second end of the plurality of tracks opposite the first end, wherein the first winch and the second winch are each coupled to the cementitious material supply system, wherein the first winch and the second winch are configured to control movement of the cementitious material supply system.

10. The system of claim 1, wherein the cementitious material supply system comprises a bias cut conveyer assembly, comprising:
a housing defining an inner chamber and a slot disposed in a bottom wall of the housing and fluidly coupled to the inner chamber; and
a conveyer disposed in fluid receiving communication with the slot, wherein the conveyer is oriented in a feed direction, wherein the housing is oriented at an oblique angle relative to the feed direction, and wherein the slot is oriented substantially perpendicular to the feed direction.

11. The system of claim 1, wherein the cementitious material supply system comprises a hopper and a rotary valve, wherein the hopper defines an interior cavity that is configured to receive the powdered cementitious material or the semi-powdered cementitious material, wherein the hopper further defines a slot disposed in a lower wall of the hopper, and wherein the rotary valve is coupled to the hopper and arranged in fluid receiving communication with the slot.

12. The system of claim 11, wherein the rotary valve further comprises:
a cylindrical shaft; and
a plurality of ridges coupled to an outer surface of the cylindrical shaft, wherein each of the plurality of ridges extends in a longitudinal direction along the outer surface in substantially parallel orientation relative to a central axis of the cylindrical shaft, and wherein each of the plurality of ridges defines a substantially planar outer surface spaced apart from the cylindrical shaft.

13. The system of claim 1, wherein the cementitious material supply system further comprises:
an unbagging system, comprising:
a hoist configured to support a sack of the powdered cementitious material or the semi-powdered cementitious material;
a control valve disposed beneath the hoist and configured to be in fluid receiving communication with the sack; and
a messaging paddle disposed beneath the hoist and configured to manually manipulate a portion of the sack.

14. The system of claim 1, wherein the cementitious material supply system further comprises:
an intermediate hopper configured to receive and hold a volume of the powdered cementitious material or the semi-powdered cementitious material therein; and
a hopper-to-dispenser transfer system configured to provide a metered quantity of the powdered cementitious material or the semi-powdered cementitious material from the intermediate hopper.

15. The system of claim 1, wherein the sealing layer comprises a membrane, and wherein the system further comprises a membrane unwinding system comprising:
a roll of membrane, wherein the membrane is an impermeable material;
an idler roller;
a load cell roller disposed proximate to the idler roller, wherein the load cell roller is configured to receive the membrane from the roll of membrane; and
a load cell coupled to the load cell roller and configured to measure a force indicative of a tension on the membrane.

16. The system of claim 1, further comprising a first adhesive application system, wherein the first adhesive application system comprises:
a fume hood; and
a plurality of heated nozzles disposed substantially within the fume hood, wherein each of the plurality of heated nozzles is configured to dispense an adhesive over the receiving material.

17. The system of claim 1, further comprising a cutting system, comprising:
a plurality of heated bars; and
a cutting blade disposed between two of the plurality of heated bars.

18. The system of claim 1, further comprising a first compression system, comprising:
at least two pairs of rollers configured to compress the receiving material, wherein a single roller of each pair of rollers is configured to apply tension to the receiving material; and
a pneumatic actuator configured to push at least one pair of the at least two pairs of rollers together.

19. The system of claim 1, further comprising a compression and cement distribution system comprising:
at least two pairs of diametrically opposed rollers, each pair including an upper roller and a lower roller;
an actuator configured to apply a predetermined force to press each of the upper rollers against a corresponding one of the lower rollers; and
a brush disposed between each pair of diametrically opposed rollers.

20. The system of claim 19, wherein the brush is one of a plurality of brushes, and wherein a first brush is disposed between a first pair of rollers and a second pair of rollers, and wherein a second brush is disposed on an opposite side of the second pair of rollers as the first brush, and wherein the first brush is coarser than the second brush.

21. The system of claim 1, wherein the system further comprises a heating system configured to soften an upper portion of the structural layer.

22. The system of claim 1, further comprising a bonding system configured to apply a containment layer to the receiving material to seal the second side of the structural layer such that the powdered cementitious material or the semi-powdered cementitious material is at least partially encased between the sealing layer and the containment layer.

23. The system of claim 22, wherein the bonding system further comprises a second adhesive application system configured to apply an adhesive material to a receiving material facing side of the containment layer.

24. The system of claim 22, wherein the bonding system further comprises a clamping and cutting system configured to process a leading edge and a trailing edge of the receiving material and the containment layer, wherein the clamping and cutting system further comprises:
a leading edge cutting bar;
a trailing edge cutting bar oriented substantially parallel to the leading edge cutting bar; and
a press bar disposed between the leading edge cutting bar and the trailing edge cutting bar.

25. The system of claim 22, wherein the bonding system further comprises an edge forming system, wherein the edge forming system comprises:
a plurality of edge rollers configured to form the containment layer downward toward the receiving material along an edge of the receiving material; and
a tucking device configured to fold the containment layer around the edge of the receiving material.

26. The system of claim 25, wherein the tucking device comprises an upper support and a plate hingedly coupled to the upper support; and an actuator configured to force the plate down and around a lateral edge of the receiving material.

27. A method of making a cementitious composite, comprising:
providing a receiving material, comprising:
a structural layer comprising an open continuous volume extending from a first side to a second side opposite the first side; and
a sealing layer coupled to the first side; and
dispensing a powdered cementitious material or a semi-powdered cementitious material into the open continuous volume to fill the open continuous volume.

28. The method of claim 27, wherein dispensing the powdered cementitious material or the semi-powdered cementitious material comprises filling the structural layer from the first side to the second side.

29. The method of claim 27, wherein dispensing the powdered cementitious material or the semi-powdered cementitious material comprises continuously spreading the powdered cementitious material or the semi-powdered cementitious material over the receiving material.

30. The method of claim 27, wherein dispensing the powdered cementitious material or the semi-powdered cementitious material comprises non-continuously spreading the powdered cementitious material or the semi-powdered cementitious material in multiple discrete stages over the receiving material.

31. The method of claim 27, wherein the powdered cementitious material or the semi-powdered cementitious material is dispensed into the receiving material using at least one of:
a hopper and a screed coupled to the hopper;
a hopper and a compressed air system coupled to the hopper;
a bias cut conveyer assembly;
a hopper and a rotary valve coupled to the hopper;
a rotary valve;
a hopper and mechanical shaker system coupled to the hopper; or
a batched dumping system.

32. The method of claim 27, wherein depositing the powdered cementitious material or the semi-powdered cementitious material comprises moving the receiving material through a stationary cementitious material supply system.

33. The method of claim 27, wherein depositing the powdered cementitious material or the semi-powdered cementitious material comprises moving a cementitious material supply system over the receiving material.

34. The method of claim 33, wherein depositing the powdered cementitious material or the semi-powdered cementitious material comprises moving the cementitious material supply system along a plurality of tracks that are coupled to the cementitious material supply system.

35. The method of claim 27, wherein dispensing the powdered cementitious material or the semi-powdered cementitious material comprises:
unbagging a pre-filled sack of the powdered cementitious material or the semi-powdered cementitious material;
transferring the powdered cementitious material or the semi-powdered cementitious material to an intermediate hopper;
transferring the powdered cementitious material or the semi-powdered cementitious material to a distribution system; and
distributing the powdered cementitious material or the semi-powdered cementitious material onto the receiving material.

36. The method of claim 35, wherein the pre-filled sack of the powdered cementitious material or the semi-powdered cementitious material is unbagged using an unbagging system, comprising:
a hoist configured to support the pre-filled sack of the powdered cementitious material or the semi-powdered cementitious material;
a control valve disposed beneath the hoist and configured to be in fluid receiving communication with the pre-filled sack; and
a messaging paddle disposed beneath the hoist and configured to manually manipulate a portion of the pre-filled sack.

37. The method of claim 27, wherein dispensing the powdered cementitious material or the semi-powdered cementitious material comprises:
feeding the receiving material and the powdered cementitious material or the semi-powdered cementitious material through at least two pairs of diametrically opposed rollers, each pair of diametrically opposed rollers including an upper roller and a lower roller;
applying a force to compress together each of the upper rollers and the lower rollers; and
feeding the receiving material through a brush disposed between two of the at least two pairs of diametrically opposed rollers.

38. The method of claim 27, further comprising applying a containment layer to the receiving material to seal the second side of the structural layer such that the powdered cementitious material or the semi-powdered cementitious material is at least partially encased between the sealing layer and the containment layer.

39. The method of claim 38, wherein applying the containment layer to the receiving material comprises applying an adhesive material to a receiving material facing side of the containment layer.

40. The method of claim 38, wherein applying the containment layer to the receiving material comprises:
forming the containment layer downward toward the receiving material along an edge of the receiving material; and
folding the containment layer around the edge of the receiving material.
